(19) United States
(12) Patent Application Publication
(10) Pub. No.: US 2026/0042004 A1
(43) Pub. Date: Feb. 12, 2026

(54) STATE MANAGEMENT FOR VIDEO GAME HELP SESSIONS

(71) Applicant: Microsoft Technology Licensing, LLC, Redmond, WA (US)

(72) Inventors: Monica Ann ADJEMIAN, Los Angeles, CA (US); Jennifer R. GURIEL, Kirkland, WA (US); Gershom PAYZER, Redmond, WA (US)

(73) Assignee: Microsoft Technology Licensing, LLC, Redmond, WA (US)

(21) Appl. No.: 18/797,960

(22) Filed: Aug. 8, 2024

(51) Int. Cl. A63F 13/493; A63F 13/52

(52) U.S. Cl. CPC A63F 13/493; A63F 13/52

(57) ABSTRACT

The disclosed concepts relate to providing help sessions for video game players. For instance, a help session starting state can be obtained from a video game session by a particular video game player. The help session starting state can be loaded into a help session. During the help session, inputs received from a client device of a video game helper can be directed to the help session. After the help session, an updated help session state can be obtained. In some cases, the particular video game player can choose to accept the updated help session state and proceed with video game play from that state. In other cases, the particular video game player can choose to reject that state and return back to the help session starting state.

### CROSS-REFERENCE TO RELATED APPLICATIONS

This application is related to, and incorporates by reference in their entirety, the following: U.S. patent application Ser. No. ______ (Attorney Docket No. 502018-US01), U.S. patent application Ser. No. ______ (Attorney Docket No. 502019-US01), U.S. patent application Ser. No. ______ (Attorney Docket No. 502020-US01), U.S. patent application Ser. No. ______ (Attorney Docket No. 502021-US01), and U.S. patent application Ser. No. ______ (Attorney Docket No. 502022-US01).

### BACKGROUND

Video game players often encounter difficult gaming situations, such as difficult enemies, difficult items to find, difficult levels to complete, etc. In some cases, video game players will seek the assistance of other video players, e.g., by posting on online forums to get suggestions from other members of the video gaming community to overcome difficult parts of a given game. In other cases, video game players consult online videos of other players demonstrating how to overcome difficult gaming situations. However, these techniques are rather rudimentary.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The description generally relates to video game help sessions. One example entails a computer-implemented method or technique that can include, during a current gaming session, offering a current video game player a cloud-based help session relating to a particular video game. The method or technique can also include obtaining a help session starting state from a saved state of game play by the current video game player. The method or technique can also include loading the help session starting state into a cloud-based help session of the particular video game. The method or technique can also include receiving video game inputs from a client device of a video game helper during the cloud-based help session. The method or technique can also include directing the video game inputs to the cloud-based help session while sending streaming output of the particular video game to the client device of the video game helper. The method or technique can also include obtaining an updated help session state of the particular video game after the cloud-based help session. The method or technique can also include in at least one instance, providing the updated help session state to the current gaming session.

Another example entails a system that includes processing resources and storage resources. The storage resources can store computer-readable instructions which, when executed by the processing resources, cause the processing resources to, during a current gaming session, offer a current video game player a cloud-based help session relating to a particular video game. The computer-readable instructions can also cause the system to obtain a help session starting state from a saved state of game play by the current video game player. The computer-readable instructions can also cause the system to load the help session starting state into a cloud-based help session of the particular video game. The computer-readable instructions can also cause the system to receive video game inputs from a client device of a video game helper during the cloud-based help session. The computer-readable instructions can also cause the system to direct the inputs to the cloud-based help session while sending streaming output of the particular video game to the client device of the video game helper. The computer-readable instructions can also cause the system to obtain an updated help session state of the particular video game after the cloud-based help session. The computer-readable instructions can also cause the system to in at least one instance, provide the updated help session state to the current gaming session.

Another example includes a computer-readable storage medium storing computer-readable instructions which, when executed by a hardware processing unit cause the hardware processing unit to perform acts. The acts can include, during a current gaming session, offering a current video game player a cloud-based help session relating to a particular video game. The acts can also include obtaining a help session starting state from a saved state of game play by the current video game player. The acts can also include loading the help session starting state into a cloud-based help session of the particular video game. The acts can also include receiving video game inputs from a client device of a video game helper during the cloud-based help session. The acts can also include directing the inputs to the cloud-based help session while sending streaming output of the particular video game to the client device of the video game helper. The acts can also include obtaining an updated help session state of the particular video game after the cloud-based help session. The acts can also include in at least one instance, providing the updated help session state to the current gaming session.

The above-listed examples are intended to provide a quick reference to aid the reader and are not intended to define the scope of the concepts described herein.

### BRIEF DESCRIPTION OF THE DRAWINGS

The Detailed Description is described with reference to the accompanying figures. In the figures, the left-most digit(s) of a reference number identifies the figure in which the reference number first appears. The use of similar reference numbers in different instances in the description and the figures may indicate similar or identical items.

FIG. 1 illustrates an example machine learning model, consistent with some implementations of the present concepts.

FIG. 2 illustrates an example computer vision model, consistent with some implementations of the present concepts.

FIG. 3 illustrates an example generative language model, consistent with some implementations of the present concepts.

FIGS. 4A and 4B illustrate example help session triggering conditions for a first video game, consistent with some implementations of the present concepts.

FIGS. 5A and 5B illustrate example help session triggering conditions for a second video game, consistent with some implementations of the present concepts.

FIGS. 6A, 6B, 6C, 6D, 6E, 6F, 6G, 6H, and 6I illustrate an example help session for the first video game, consistent with some implementations of the present concepts.

FIG. 7 illustrates an example workflow for implementing help sessions, consistent with some implementations of the present concepts.

FIG. 8A illustrates an example system in which the present concepts can be employed.

FIGS. 8B, 8C, 8D, and 8E illustrate examples of communicating inputs and outputs during a help session, consistent with some implementations of the present concepts.

FIG. 9 illustrates a method for implementing a help session, consistent with some implementations of the present concepts.

### DETAILED DESCRIPTION

### Overview

As noted above, video game players sometimes seek help from other video game players to overcome in-game difficulties, often by consulting online forums or videos. However, while this type of help is widely available, it takes a great deal of effort for users to seek out the assistance they need to accomplish their goal. Furthermore, these techniques may take the video game players out of the gaming experience while they search for external help content.

The disclosed implementations aim to address these issues by providing help sessions to video game players. For instance, the help sessions can assist video game players in overcoming difficult in-game situations where they may tend to fail or otherwise become frustrated with the gaming experience. In some cases, help sessions are implemented where control of a video game is temporarily transferred from a current gaming session of a current video game player to a help session. After the help session, control is transferred back to the current video game player, potentially updating the state of the current gaming session based on state changes that occurred during the help session.

### Machine Learning Overview

There are various types of machine learning frameworks that can be trained to perform a given task, such as detecting triggering conditions and ending conditions for help sessions. Support vector machines, decision trees, random forests, and neural networks are just a few examples of suitable machine learning frameworks that have been used in a wide variety of other applications, such as image processing and natural language processing.

A support vector machine is a model that can be employed for classification or regression purposes. A support vector machine maps data items to a feature space, where hyperplanes are employed to separate the data into different regions. Each region can correspond to a different classification. Support vector machines can be trained using supervised learning to distinguish between data items having labels representing different classifications.

A decision tree is a tree-based model that represents decision rules using nodes connected by edges. Decision trees can be employed for classification or regression and can be trained using supervised learning techniques. Multiple decision trees can be employed in a random forest, which significantly improve the accuracy of the resulting model relative to a single decision tree. In a random forest, the individual outputs of the decision trees are collectively employed to determine a final output of the random forest. For instance, in regression problems, the output of each individual decision tree can be averaged to obtain a final result. For classification problems, a majority vote technique can be employed, where the classification selected by the random forest is the classification selected by the most decision trees.

A neural network is another type of machine learning model that can be employed for classification or regression tasks. In a neural network, nodes are connected to one another via one or more edges. A neural network can include an input layer, an output layer, and one or more intermediate layers. Individual nodes can process their respective inputs according to a predefined function, and provide an output to a subsequent layer, or, in some cases, a previous layer. The inputs to a given node can be multiplied by a corresponding weight value for an edge between the input and the node. In addition, nodes can have individual bias values that are also used to produce outputs.

Various training procedures can be applied to learn the edge weights and/or bias values of a neural network. The term “internal parameters” is used herein to refer to learnable values such as edge weights and bias values that can be learned by training a machine learning model, such as a neural network. The term “hyperparameters” is used herein to refer to characteristics of model training, such as learning rate, batch size, number of training epochs, number of hidden layers, activation functions, etc.

A neural network structure can have different layers that perform different specific functions. For example, one or more layers of nodes can collectively perform a specific operation, such as pooling, encoding, decoding, alignment, prediction, or convolution operations. For the purposes of this document, the term “layer” refers to a group of nodes that share inputs and outputs, e.g., to or from external sources or other layers in the network. The term “operation” refers to a function that can be performed by one or more layers of nodes. The term “model structure” refers to an overall architecture of a layered model, including the number of layers, the connectivity of the layers, and the type of operations performed by individual layers. The term “neural network structure” refers to the model structure of a neural network. The term “trained model” and/or “tuned model” refers to a model structure together with internal parameters for the model structure that have been trained or tuned, e.g., individualized tuning to one or more particular users. Note that two trained models can share the same model structure and yet have different values for the internal parameters, e.g., if the two models are trained on different training data or if there are underlying stochastic processes in the training process.

### Terminology

The term “prior gameplay data,” as used herein, refers to various types of data associated with gameplay of a video game. Prior gameplay data can include gameplay sequences, e.g., of inputs to a video game and/or outputs of the video game during prior gaming sessions. Prior gameplay data can also include communication logs relating to the game, such as in-game chat or voice sessions or external data such as forum posts regarding a particular game. Prior gameplay data can also include platform data collected by a video gaming platform, such as an online game playing service utilized by multiple video games or an operating system that runs on a gaming console. Prior gameplay data can also include instrumented game data that can be stored by the video game itself during execution for subsequent evaluation. Note that prior gameplay data can include very recent gameplay data obtained in real-time from live video game play.

A “help session” is an experience that occurs to assist a video game player with a particular portion of a video game. For instance, a help session can include a tutorial, e.g., text, chat, or video-based. A help session can also include transferring control of a video game session to another game player that temporarily takes over control of a video game until the help session is completed. The other game player can be a human being or, in some cases, a machine learning model. A “help session starting state” is a state of a video game used to start a help session. A help session starting state can be a previously-saved state or a current state of a video game. An “updated help session state” is a state of a video game that occurs as a result of inputs directed to the video game during a help session. A “helper” or “video game helper” is a human or machine learning model that plays a video game during a help session.

The term “generative model,” as used herein, refers to a machine learning model employed to generate new content. One type of generative model is a “generative language model,” which is a model that can generate new sequences of text given some input. One type of input for a generative language model is a natural language prompt, e.g., a query potentially with some additional context. For instance, a generative language model can be implemented as a neural network, e.g., a long short-term memory-based model, a decoder-based generative language model, etc. Examples of decoder-based generative language models include versions of models such as ChatGPT, BLOOM, PaLM, Mistral, Gemini, and/or LLAMA. Generative language models can be trained to predict tokens in sequences of textual training data. When employed in inference mode, the output of a generative language model can include new sequences of text that the model generates.

Another type of generative model is a “generative image model,” which is a model that generates images or video. For instance, a generative image model can be implemented as a neural network, e.g., a generative image model such as one or more versions of Stable Diffusion, DALL-E, Sora, or GENIE. A generative image model can generate new image or video content using inputs such as a natural language prompt and/or an input image or video. One type of generative image model is a diffusion model, which can add noise to training images and then be trained to remove the added noise to recover the original training images. In inference mode, a diffusion model can generate new images by starting with a noisy image and removing the noise.

In some cases, a generative model can be multi-modal. For instance, a multi-modal generative model may be capable of using various combinations of text, images, video, audio, application states, code, or other modalities as inputs and/or generating combinations of text, images, video, audio, application states, or code or other modalities as outputs. Here, the term “generative language model” encompasses multi-modal generative models where at least one mode of output includes natural language tokens. Likewise, the term “generative image model” encompasses multi-modal generative models where at least one mode of output includes images or video. Examples of multi-modal models include CLIP models, certain GPT variants such as GPT-4o, Gemini, etc. The term “prompt,” as used herein, refers to input provided to a generative model that the generative model uses to generate outputs. A prompt can be provided in various modalities, such as text, an image, audio, video, etc.

In addition, some generative models can include computer vision capabilities. These models are capable of recognizing objects in input images. The term “computer vision model” encompasses multi-modal models such as one or more versions of CLIP (Contrastive Language-Image Pre-Training) and BLIP (Bootstrapping Language-Image Pre-Training). Note the term “computer vision model” also encompasses non-generative models, such as ResNet, Faster-RCNN, etc.

The term “machine learning model” refers to any of a broad range of models that can learn to generate automated user input and/or application output by observing properties of past interactions between users and applications. For instance, a machine learning model could be a neural network, a support vector machine, a decision tree, a clustering algorithm, etc. In some cases, a machine learning model can be trained using labeled training data, a reward function, or other mechanisms, and in other cases, a machine learning model can learn by analyzing data without explicit labels or rewards.

### Example Neural Network

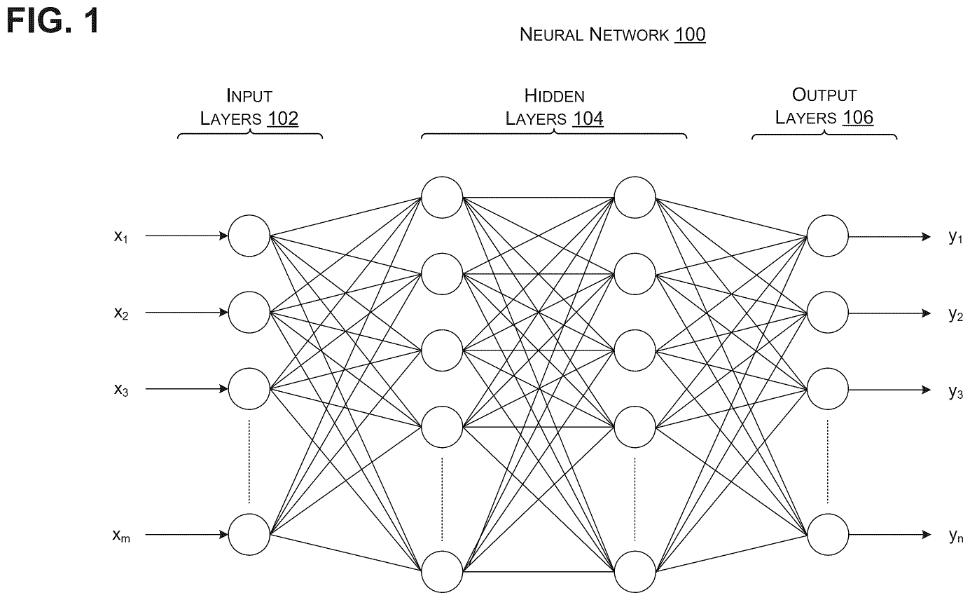

FIG. 1 shows a deep neural network 100 with input layers 102, hidden layers 104, and output layers 106. The input layers can receive features x₁ through xₘ. For instance, the features can relate to prior or current gameplay data for one or more video games, and can include features relating to gameplay sequences by one or more players, features relating to communication logs from players discussing the video game, features relating to platform data collected by a gaming platform that executes the video game, and/or game data (e.g., telemetry) collected by the video game itself when executing.

The input layers 102 can feed into the hidden layers 104. The hidden layers calculate values based on the inputs received from the input layers, and feed results of the calculations into the output layers 106. The output layers can output values y₁ through yₙ. For instance, the output values can characterize any aspect of video game play at any point during the video game. In some cases, the output values are calculated using a regression approach, and in other cases using a classification approach.

In a regression approach, the output values can characterize any aspect of a video game using a numerical value. For instance, one output layer could generate a value indicating a predicted difficulty level of an achievement, another output layer could output a value indicating a predicted disengagement rating for a specific video game scenario, etc. In other cases, the output values could characterize a help score of one or more video game helpers for a particular help session, e.g., based on one or more input features representing a starting state of the help session.

In a classification approach, the output values can include probability distributions over two or more classes. For instance, one output layer could output a binary probability distribution that a user will stop playing a video game under certain circumstances, another output layer could output a binary probability distribution that the user will accept a help session, etc. In other cases, the output values could be Boolean values representing whether one or more video game helpers can be selected to help for a particular help session, e.g., based on one or more input features representing a starting state of the help session.

Deep neural network 100 is shown with a general architecture that can be modified depending on the task being performed by the neural network. For instance, neural networks can be implemented with convolutional layers to implement a computer vision model or as a transformer encoder/decoder architecture to implement a generative language or multi-modal generative model. Neural networks can also have recurrent layers such as long short-term memory networks, gated recurrent units, etc.

### Example Computer Vision Model

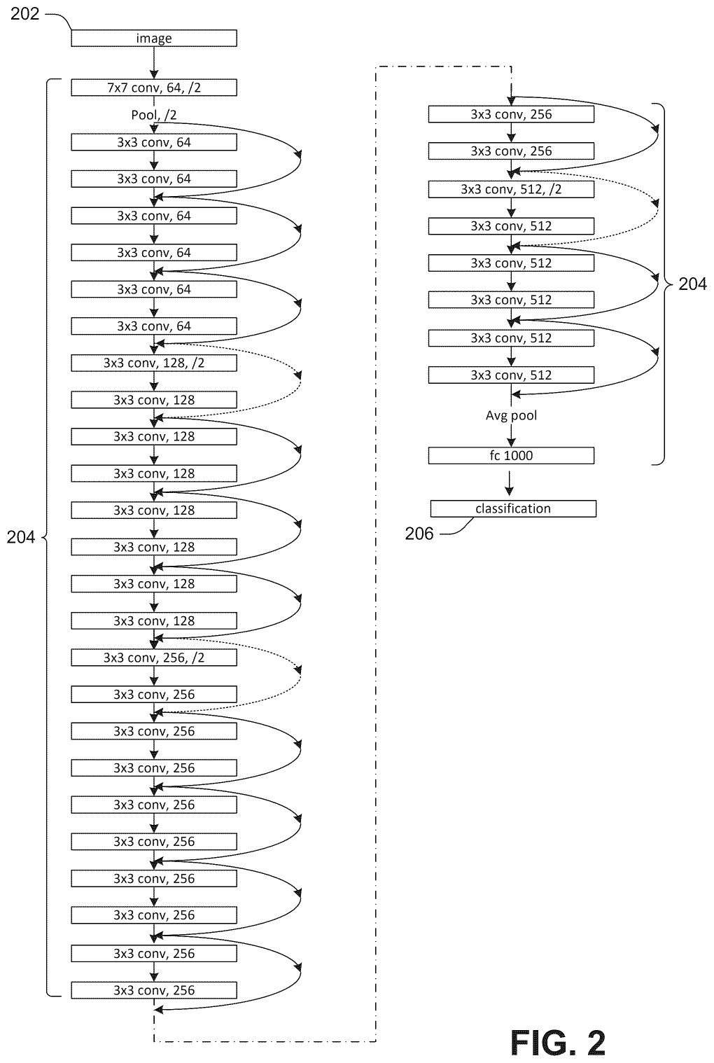

While FIG. 1 illustrates a general architecture of a neural network, FIG. 2 illustrates a particular example of a neural network model for computer vision. For instance, FIG. 2 shows an image 202 being classified by a computer vision model 204 to determine an image classification 206. For instance, the image can include part or all of a video frame output by a video game, and computer vision model 204 can be a ResNet model (He, et al., “Deep Residual Learning for Image Recognition,” in Proceedings of the IEEE Conference on Computer Vision and Pattern Recognition, 2016, pp. 770-778). The computer vision model can include a number of convolutional layers, most of which have 3×3 filters. Generally, given the same output feature map size, the convolutional layers have the same number of filters. If the feature map size is halved by a given convolutional layer (as shown by “l2” in FIG. 2), then the number of filters can be doubled to preserve the time complexity across layers.

After the image has been processed using a series of convolutional layers, the image is processed in a global average pooling layer. The output of the pooling layer is processed with a 1000-way fully-connected layer with softmax. The fully-connected layer can be used to determine a classification, e.g., an object category of an object in image 202.

The respective layers within computer vision model 204 can have shortcut connections which perform identity operations:

$$y = F ( x , \{ {W}_{i} \} ) + x \qquad ( 1 )$$

where x and y are the input and output vectors of the layers involved and F(x, {Wᵢ}) represents the residual mapping to be learned. In some connections the dimensions increase across layers (shown as dotted lines in FIG. 2). In these cases, the following projection can be employed to match the dimensions via 1×1 convolutions:

$$y = F ( x , \{ {W}_{i} \} ) + {W}_{s} x \qquad ( 2 )$$

In some implementations, computer vision model 204 can be pretrained on a large dataset of images, such as ImageNet. Such a general-purpose image database can provide a vast number of training examples that allow the model to learn weights that allow generalization across a range of object categories. Said another way, computer vision model 204 can be pretrained in this fashion.

After pretraining, computer vision model 204 can be tuned on another, smaller dataset for categories of interest. For instance, tuning datasets can be provided for specific video games, genres of video games, etc. As one example, some genres of video games tend to have health status bars or important, powerful enemies (“bosses”), and computer vision model 204 could be tuned to detect health status and/or boss fight scenarios using training data from multiple games from a particular genre. For instance, the training data could include video frames with associated labels, e.g., either manually-labeled health bars or boss fights or implicit labels obtained from user chat logs, forum discussions, etc. Tuning could also be performed specifically on training data associated with help sessions for video games, e.g., to recognize visual characteristics of successful vs. unsuccessful help sessions.

### Example Decoder-Based Generative Language Model

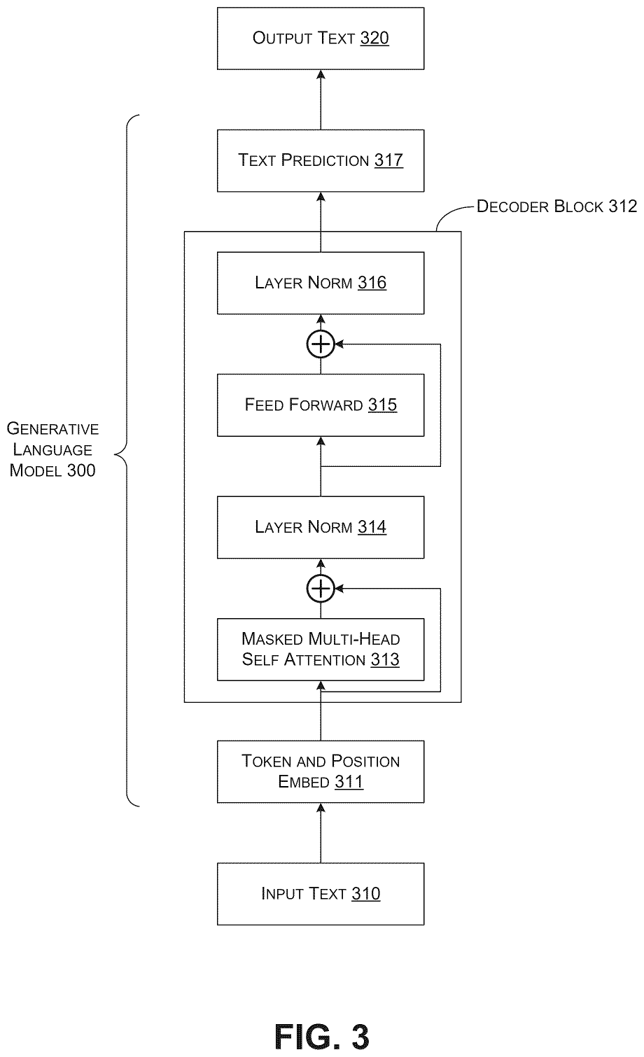

While FIG. 1 illustrates a general architecture of a neural network, FIG. 3 illustrates a particular example of a neural network model for language generation. Specifically, FIG. 3 illustrates an exemplary generative language model 300 (e.g., a transformer-based decoder) that can be employed using the disclosed implementations. Generative language model 300 is an example of a machine learning model that can be used to perform one or more natural language processing tasks that involve generating text, as discussed more below. For the purposes of this document, the term “natural language” means language that is normally used by human beings for writing or conversation.

Generative language model 300 can receive input text 310, e.g., a prompt from a user or a prompt generated automatically by machine learning using the disclosed techniques. For instance, the input text can include words, sentences, phrases, or other representations of language. The input text can be broken into tokens and mapped to token and position embeddings 311 representing the input text. Token embeddings can be represented in a vector space where semantically-similar and/or syntactically-similar embeddings are relatively close to one another, and less semantically-similar or less syntactically-similar tokens are relatively further apart. Position embeddings represent the location of each token in order relative to the other tokens from the input text.

The token and position embeddings 311 are processed in one or more decoder blocks 312. Each decoder block implements masked multi-head self-attention 313, which is a mechanism relating different positions of tokens within the input text to compute the similarities between those tokens. Each token embedding is represented as a weighted sum of other tokens in the input text. Attention is only applied for already-decoded values, and future values are masked. Layer normalization 314 normalizes features to mean values of 0 and variance to 1, resulting in smooth gradients. Feed forward layer 315 transforms these features into a representation suitable for the next iteration of decoding, after which another layer normalization 316 is applied. Multiple instances of decoder blocks can operate sequentially on input text, with each subsequent decoder block operating on the output of a preceding decoder block. After the final decoding block, text prediction layer 317 can predict the next word in the sequence, which is output as output text 320 in response to the input text 310 and also fed back into the language model. The output text can be a newly-generated response to the prompt provided as input text to the generative language model.

Generative language model 300 can be trained using techniques such as next-token prediction or masked language modeling on a large, diverse corpus of documents. For instance, the text prediction layer 317 can predict the next token in a given document, and parameters of the decoder block 312 and/or text prediction layer can be adjusted when the predicted token is incorrect. In some cases, a generative language model can be pretrained on a large corpus of documents (Radford, et al., “Improving language understanding by generative pre-training,” 2018). Then, a pretrained generative language model can be tuned using a reinforcement learning technique such as reinforcement learning from human feedback (“RLHF”). In other examples, a generative language model could be tuned using training data from a specific video game or games from a particular genre to determine when various help session criteria are met or to characterize in-game conditions relative to help session criteria. The generative language model could also be tuned to select helpers from a pool of available helpers based on input text characterizing the helpers, descriptions of video outputs from help session end states provided by computer vision models, etc.

### Example Adventure Game Sequences

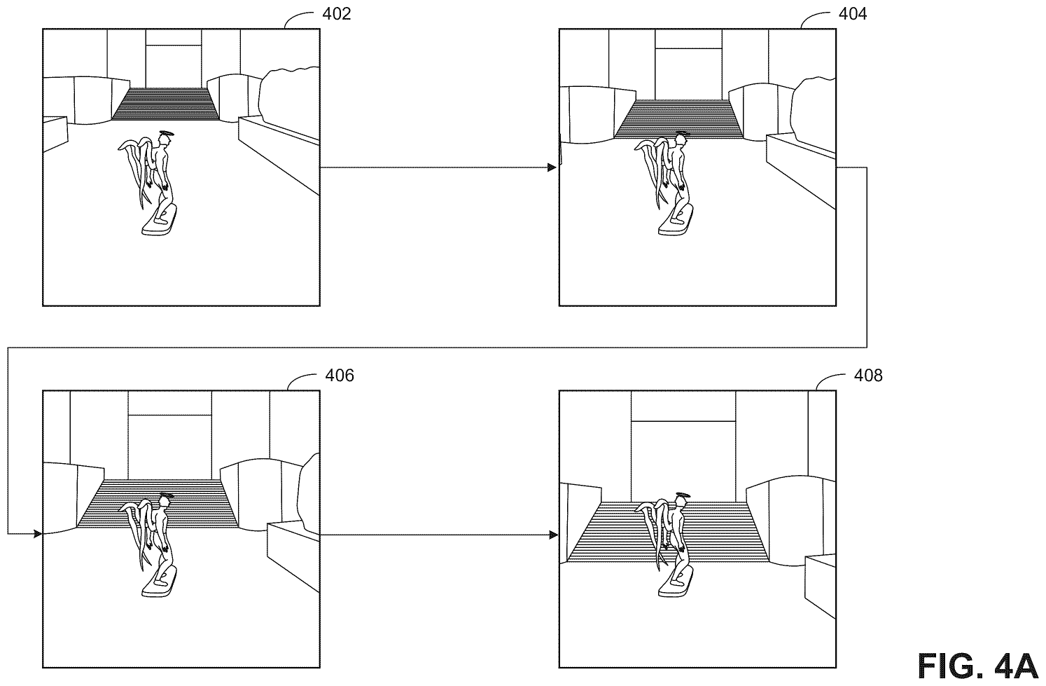

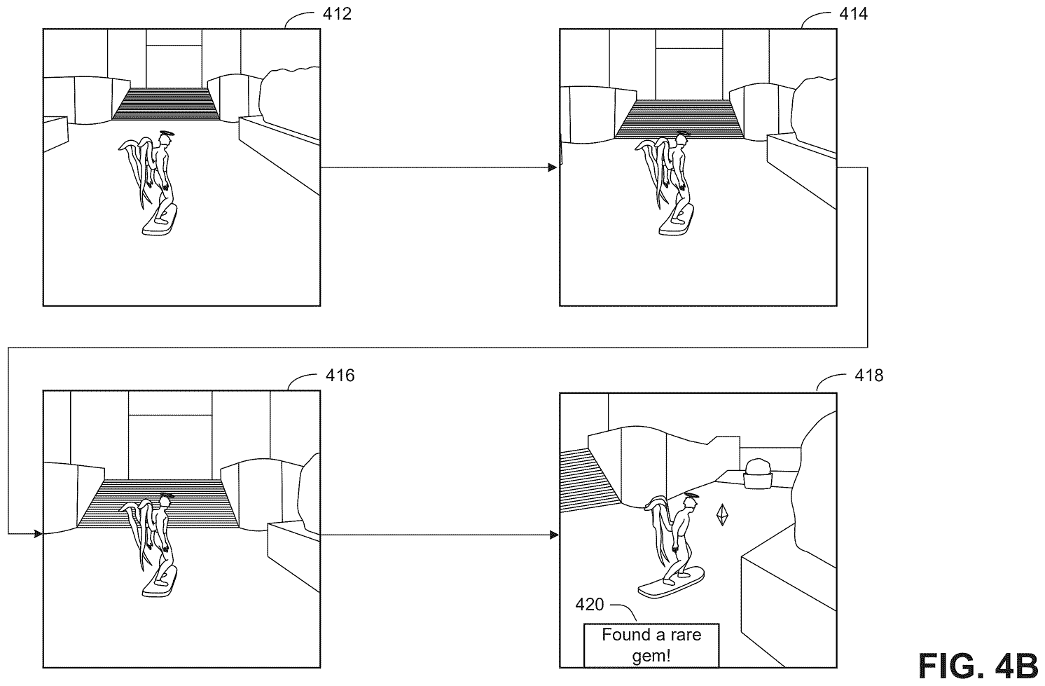

FIG. 4A shows a sequence of frames from an adventure game where a video game player controls a character riding a hoverboard. The character moves forward through frame 402, frame 404, frame 406, and frame 408, looking for a rare gem. However, the video game player is unsuccessful at finding the rare gem in this sequence of frames. FIG. 4B shows a sequence of frames from the adventure game where the character moves through a similar sequence of frames. Frame 412 is similar to frame 402, frame 414 is similar to frame 404, and frame 416 is similar to frame 406. However, unlike frame 408, at frame 418 the character turns to the right and finds a rare gem. An achievement 420 is displayed in frame 418 indicating that the user has found a rare gem.

For the purposes of the following discussion, assume that many video game players struggle with finding the rare gem and that FIG. 4A illustrates a relatively common sequence of frames. In other words, users tend to navigate too far without turning to the right at the proper time and thus do not find the rare gem. Said another way, finding the rare gem is a difficult in-game goal. Further, assume that many video game players also tend to disengage from gameplay as a result of getting frustrated by not finding the rare gem. As described more below, this can be mitigated by identifying a help session triggering condition in the video game when a current video player is in the vicinity of the rare gem, and offering that player assistance at finding the rare gem during a help session. The help session can be automatically ended when the current video game player finds the rare gem, e.g., finding the rare gem can be designated as a help session ending condition.

### Example Racing Game Sequences

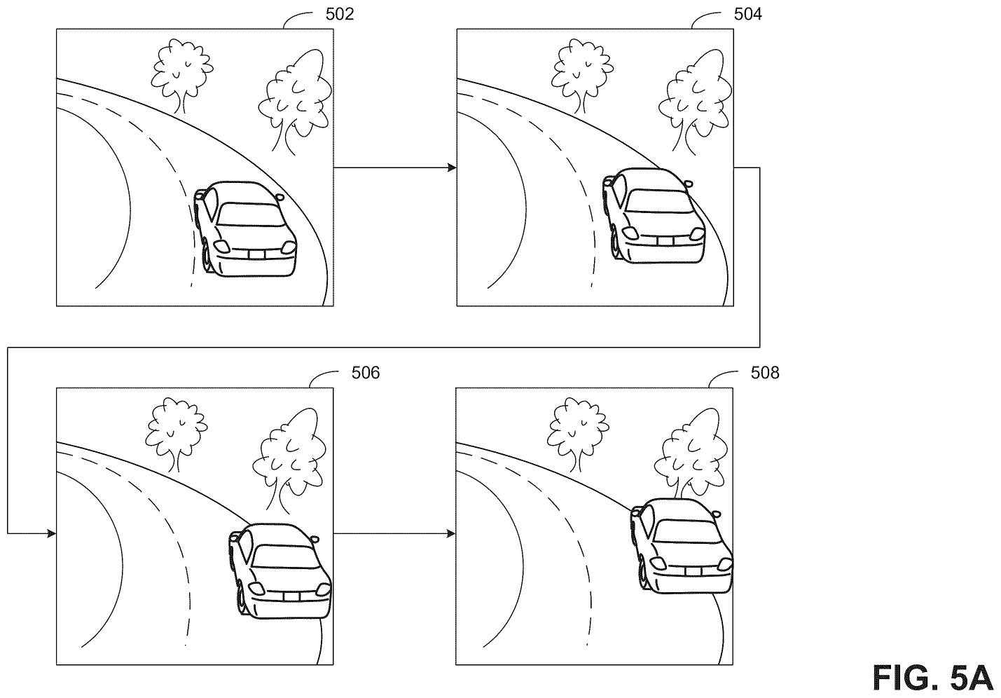

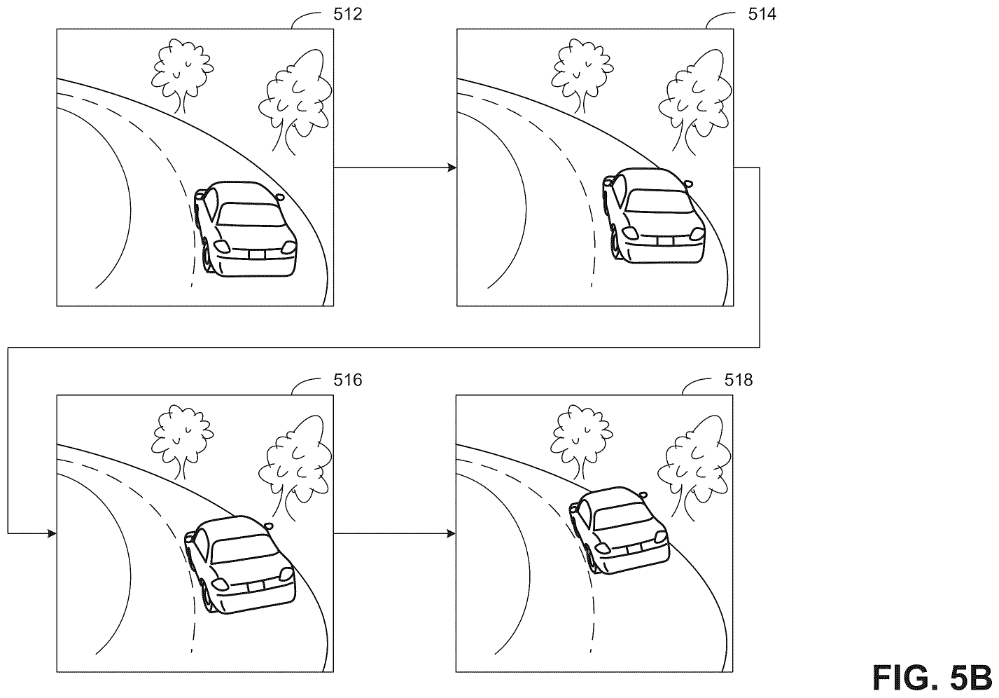

FIG. 5A shows a sequence of frames from a racing game where a video game player controls a car along a road course. The car moves forward through frame 502, frame 504, frame 506, and frame 508, eventually crashing into a tree. FIG. 5B shows a sequence of frames from the racing game where the car starts at a similar location in frame 512 to the location shown in frame 502. However, in frame 514, the car takes a different path that proceeds through frames 516 and 518, successfully staying on the road course without crashing into the tree.

For the purposes of the following discussion, assume that many video game players struggle with running into the tree, and that FIG. 5A illustrates a relatively common sequence of frames. In other words, video game players tend to misjudge this particular turn and veer into the tree rather than staying on the road when playing the game. Said another way, running into the tree is a common negative in-game consequence in the racing game. Further, assume that many video game players also tend to disengage from gameplay as a result of getting frustrated by running into the tree. As described more below, this can be mitigated by identifying a help triggering condition in the video game when a current video player is approaching the tree and offering the current video game player assistance at successfully navigating the turn during a help session. The help session can be automatically ended when the current video game player successfully navigates the turn, e.g., passing the tree without crashing can be designated as a help session ending condition.

### Example Adventure Game Help Session

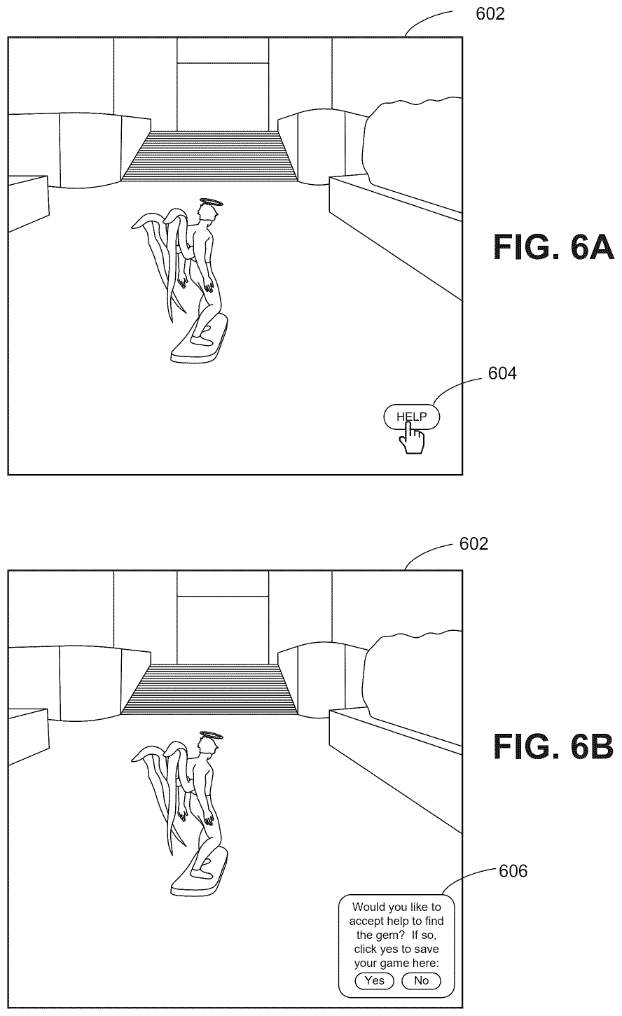

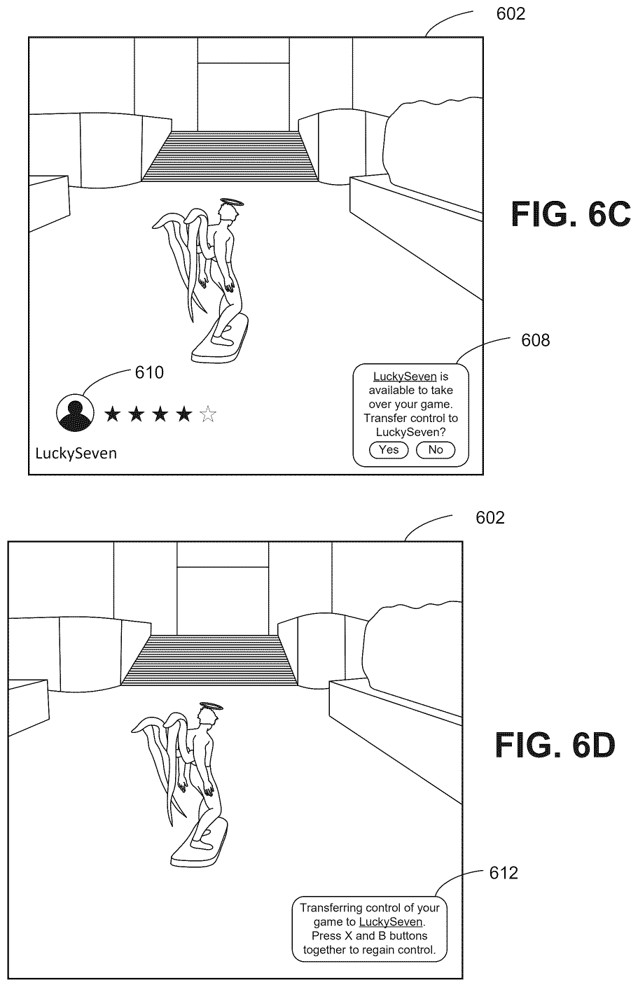

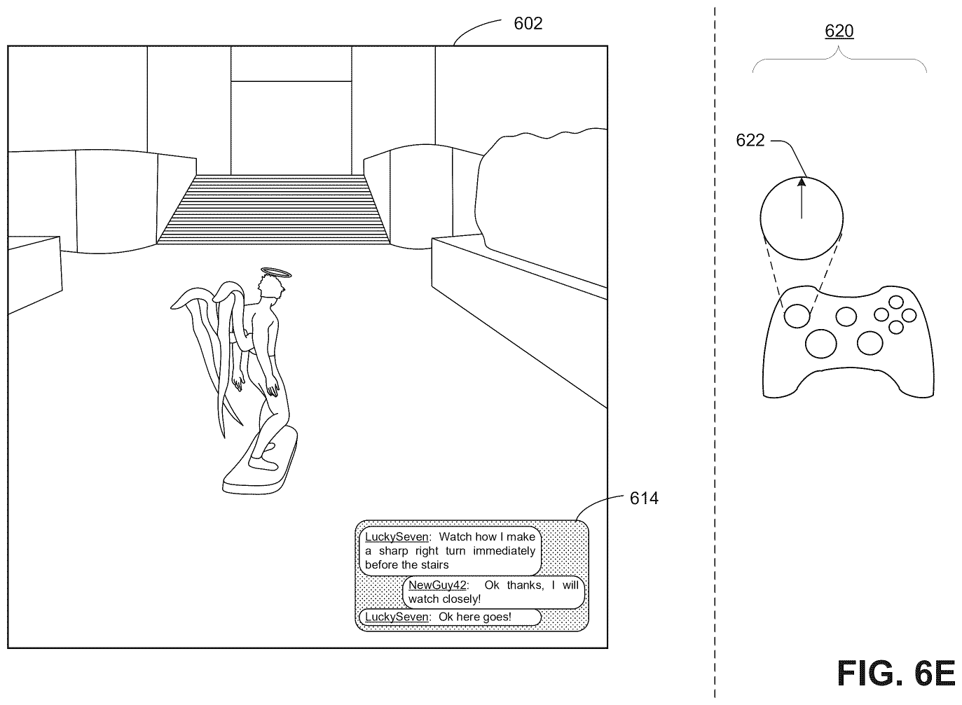

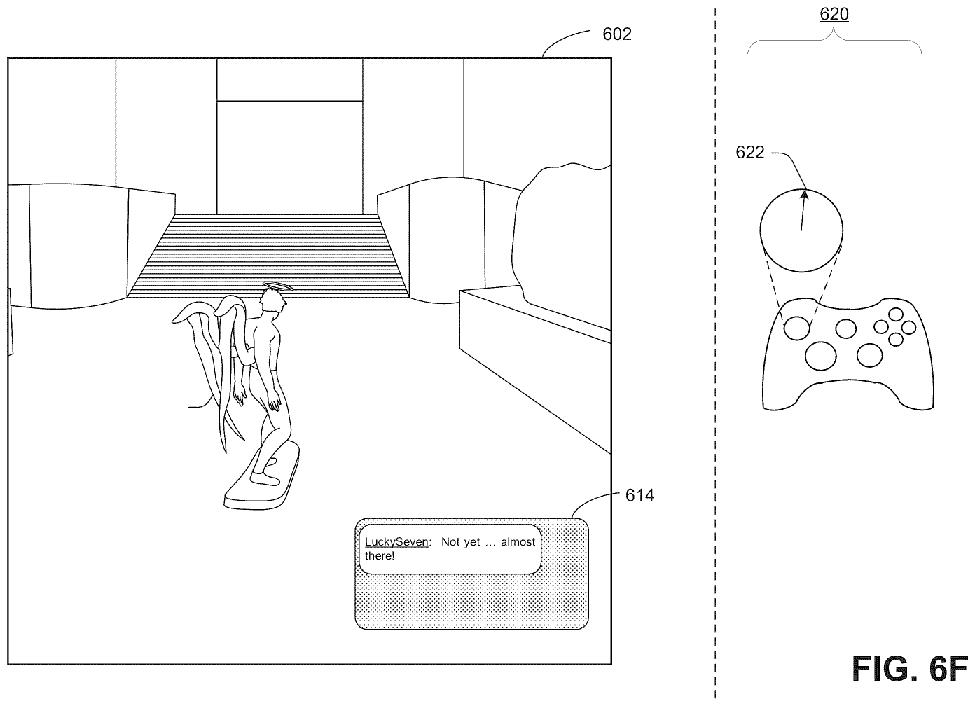

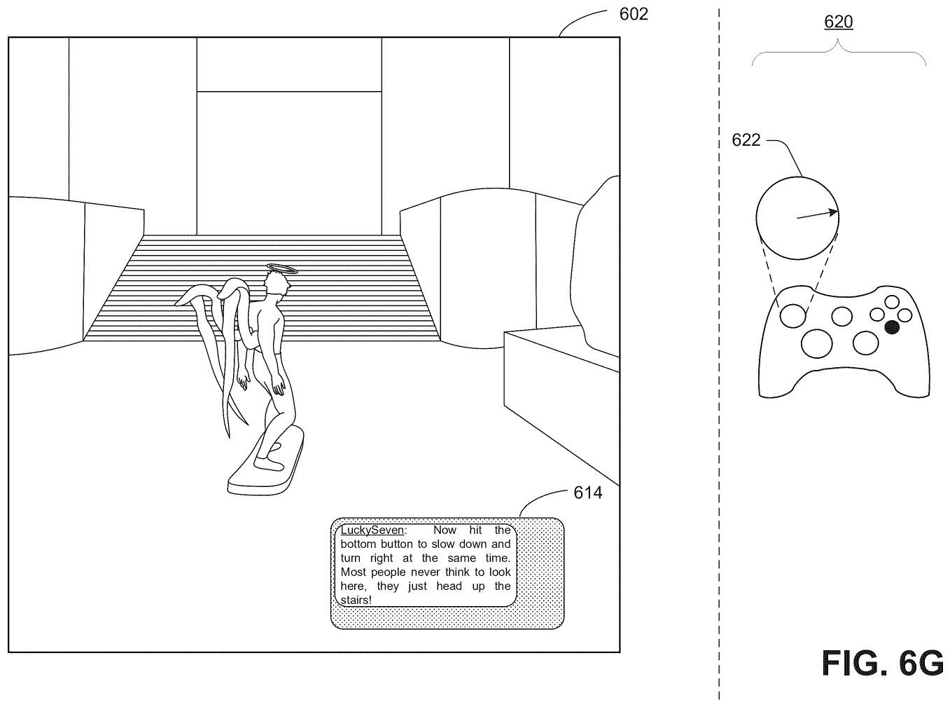

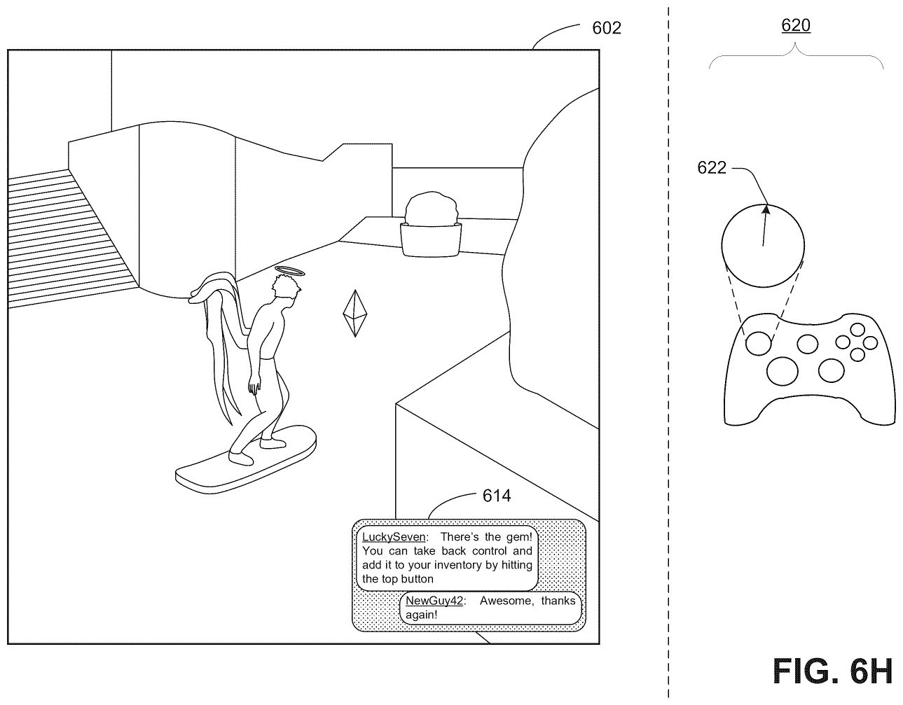

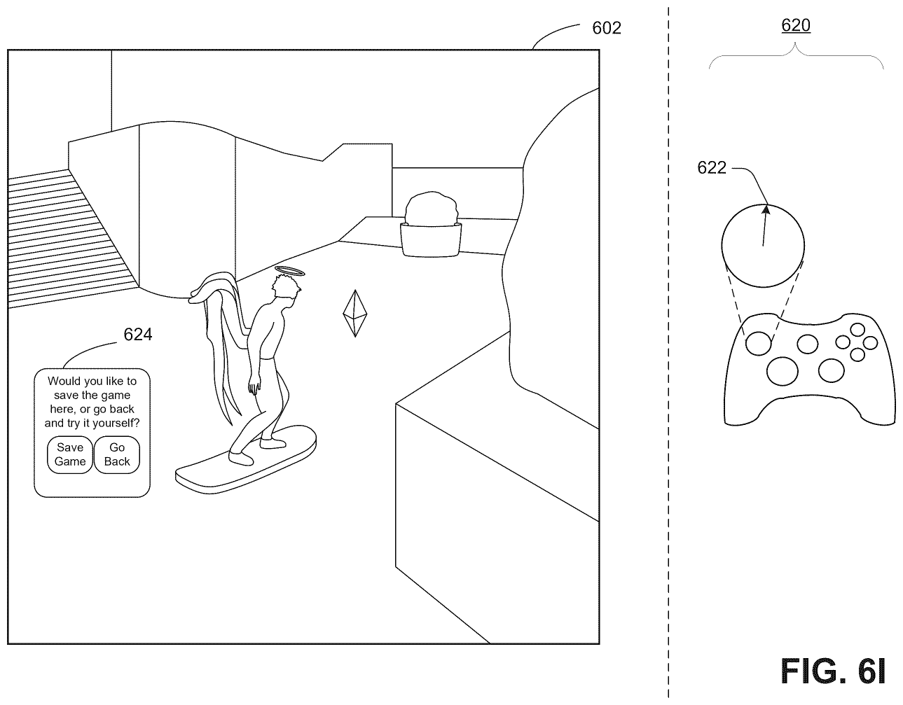

FIGS. 6A through 6I collectively illustrate an example help session experience relating to the adventure video game introduced previously. FIG. 6A shows a help session triggering condition being detected in a current video game session. Note that a video frame 602 is visually similar to frame 402 and frame 412, as discussed above with respect to FIGS. 4A and 4B. One way to detect that a help session should be offered during a current video game session is to compare the output of the current video game session to prior outputs associated with prior help sessions, e.g., by comparing embeddings representing video and/or audio output. When one or more embeddings for the current video game session are sufficiently similar to the one or more embeddings associated with the prior help sessions, the help session can be triggered.

When the help session triggering condition is detected, a help icon 604 can be presented on the screen, as shown in FIG. 6A. When the current video game player selects the help icon, a help save 606 icon is displayed, as shown in FIG. 6B. When the current video game player selects the help save icon, the current game state can be saved as a help session starting state, and the help session can proceed as follows. For instance, the current game state can represent the location of the character, items accrued in their inventory, health status, etc.

Next, a helper identification icon 608 is displayed with helper data 610, as shown in FIG. 6C. Here, the helper data indicates that the available helper is named “LuckySeven” and has a 4/5 star rating, e.g., from other users that have been helped by LuckySeven. When the current video game player clicks “yes,” then a help session transfer notification 612 is shown indicating control is being transferred to the helper, as shown in FIG. 6D.

As shown in FIG. 6E, the help session begins at frame 602 where the current video gaming session was saved. A chat dialog 614 is displayed along with a video game controller representation 620. In the chat dialog, the helper explains how to move the character to achieve the in-game goal of finding the rare gem. The video game controller representation shows the inputs provided by the helper to their own video game controller during the help session, and includes a joystick representation 622, which employs an arrow to show the direction in which the helper's joystick is pointed to maneuver the character.

Next, in FIG. 6F, the character continues along the path. The helper explains that the character is “almost there”, and the joystick representation 622 remains pointed nearly straight ahead. Next, in FIG. 6G, the joystick representation 622 moves to the right, and the bottom button on controller representation 620 is now black to indicate this button has been pressed. The chat dialog also explains that this is a point in the video game where many players do not think to look to the right and most continue to go up the stairs without finding the rare gem.

Next, in FIG. 6H, a rare gem is visible. At this time, control can return to the current video game player, e.g., the presence of the rare gem in the current video game frame can be designated as a help session ending condition. Note that the help session can be automatically ended at this point according to a help session ending condition, e.g., indicating that the rare gem was found and/or based on a comparison of an embedding representing the video frame shown in FIG. 6H to an average embedding of successful help sessions that resulted in finding the rare gem.

Next, in FIG. 6I, a help session acceptance option 624 is displayed. If the current video game player wishes to accept the option, the updated state of the video game can be loaded into the current video gaming session. Then, the current video game player can resume play from that state, e.g., having just found the rare gem. If the help session acceptance option is rejected, the current video game session can return to the help session starting state and the current video game player can attempt to find the rare gem themselves.

### Example Workflow

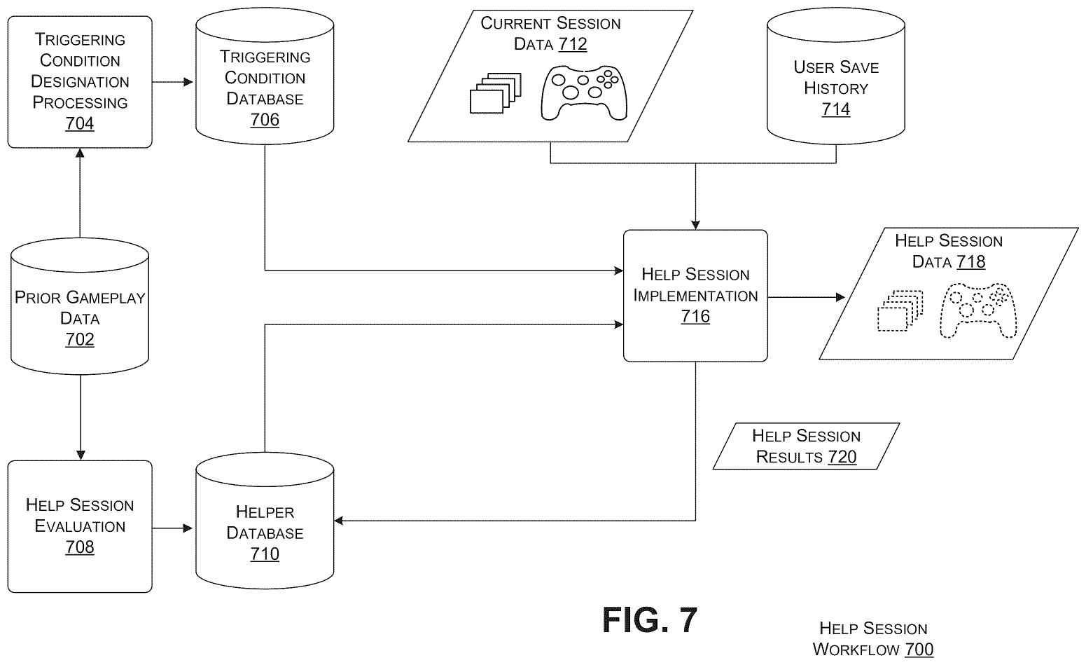

FIG. 7 shows an example help session workflow 700. Various sources of prior gameplay data 702 can be employed for designating help session triggering or ending conditions for a video game. The prior gameplay data can also be evaluated to evaluate video game helpers. For instance, the gameplay data can include gameplay sequences, communication logs, platform data, and instrumented game data, etc.

Gameplay sequences can include various sequences of video game outputs (video, audio, and/or haptic) and/or inputs obtained from one or more prior video gaming sessions. Optical character recognition can be performed on video frames in the gameplay sequences to obtain on-screen text features. In addition, machine learning can be performed on the video frames, audio output, and/or video game input to obtain ML-detected features. For instance, the ML-detected features can include object identifiers or embeddings obtained using computer vision model 204, described previously.

Communication logs can include chat or voice logs obtained during prior gaming sessions, e.g., communications between video game players when playing a particular video game. The communication logs can also include other types of communications, such as online forum discussions relating to a particular video game. The communication logs can be processed using natural language processing to obtain natural language processing features. For example, the natural language processing features can include sentiment relating to specific game scenarios.

Platform data can include data collected by a video gaming platform on which one or more video games can be executed. The platform data can include in-game achievements, saves, restarts, disengagement data, etc. The platform data can be processed using machine learning, rules, or statistical techniques to extract platform features.

Instrumented game data can include telemetry data collected by one or more video games. For example, games can track data such as levels completed, enemies defeated, etc. The instrumented game data can be processed using machine learning, rules, or statistical techniques to extract instrumented game data features.

The various features extracted from the prior gameplay data can be input to triggering condition designation processing 704. For instance, the triggering condition designation processing can involve applying one or more rules to the features to determine what conditions in a given video game will trigger a help session to begin and/or end. For instance, a rule could state that any condition that results in above a threshold percentage (e.g., 5%) of users disengaging after encountering that condition is designated as a help session triggering condition. In the examples above, the failure of a user to find a rare gem five times and then returning to the same location in the adventure game could be an example of a help session triggering condition. Similarly, a user crashing into the tree shown in FIG. 5A five times and then returning again to the same location on the track could be an example of a help session triggering condition.

In other cases, a machine learning model could be employed to designate help session triggering conditions. For instance, a generative language model or multi-modal generative could be provided with features reflecting user disengagement (e.g., from platform data). As another example, a generative model could be provided features reflecting negative in-game consequences or difficult in-game goals. The generative model could identify these conditions as appropriate conditions for triggering help sessions. In some cases, rules and or machine learning models can also be employed to designate help session ending conditions as well.

Once the help session triggering conditions have been designated, they can be used to populate a triggering condition database 706. The triggering condition database can include one or more help session triggering conditions (and possibly ending conditions) for one or more video games. Over time, the triggering condition database can evolve as circumstances change, such as updates to the video game(s).

In addition, the gameplay data can be processed by help session evaluation 708. In help session evaluation 708, the gameplay data for various help sessions is analyzed. A helper database 710 is populated based on the analysis. For instance, the helper database can include records for various video game helpers. The records can characterize how successful different video game helpers are on an overall basis, for specific video games, and/or at specific segments of video games, as described more below.

Triggering condition database 706 and helper database 710 can be populated in advance and/or on an ongoing basis as new gameplay data is received. When a current video game player is playing a particular video game, current session data 712 is received. For instance, the current session data can include output video or audio frames, controller inputs, etc. In other cases, the current session data can also include communications, platform data, or instrumented game data associated with the current gaming session. In addition, a user save history 714 is accessed to identify whether the user has one or more saved gaming sessions for the particular video game.

Help session implementation 716 can involve determining whether the current session data matches any of the triggering conditions in the triggering condition database 706. If so, then a help session can be initiated for the current video game player. The help session implementation can also involve determining when to end a help session, e.g., when a current video game player presses a specific button or buttons on their controller, or a help session ending condition is detected during gameplay. The help session implementation can also involve determining whether any helpers from helper database 710 are available and potentially selecting and/or ranking individual video game helpers, as discussed more below.

During the help session, help session data 718 is provided to a helper session of the video game. The help session data can include inputs provided by the selected video game helper as well as outputs of the video game. The help session data can also be provided to the video game player receiving assistance. The help session can result in an updated help session state, e.g., resulting from gameplay by the helper. After the help session, help session results 720 are used to update the helper database. For instance, the help session results can include a rating by the current video game player of the help session, an indication of any achievements or in-game goals that occurred during the help session, etc.

### Example System

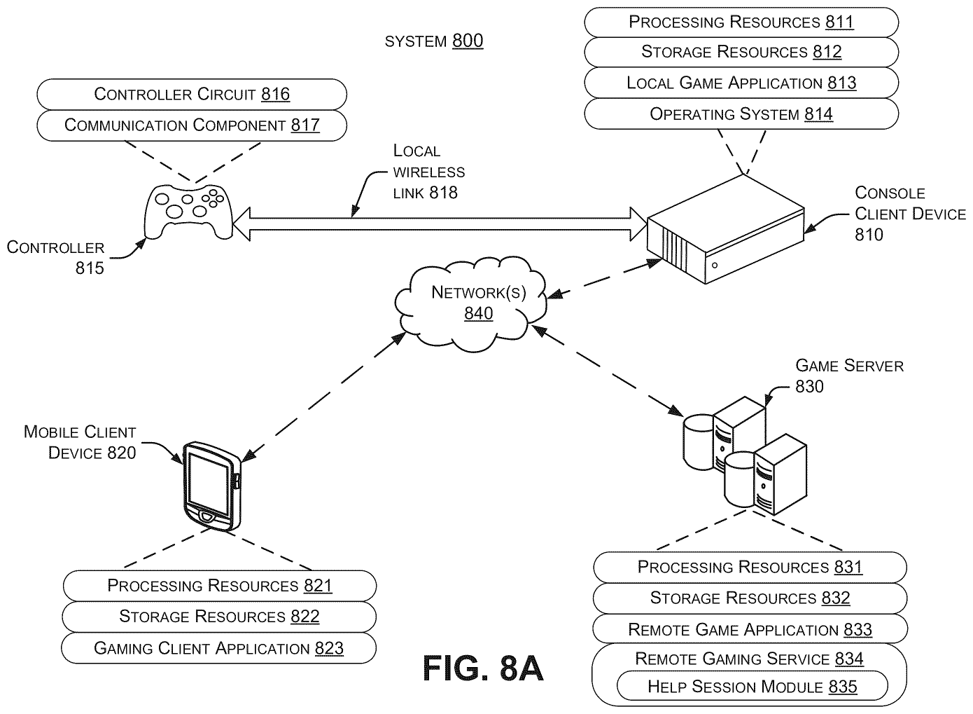

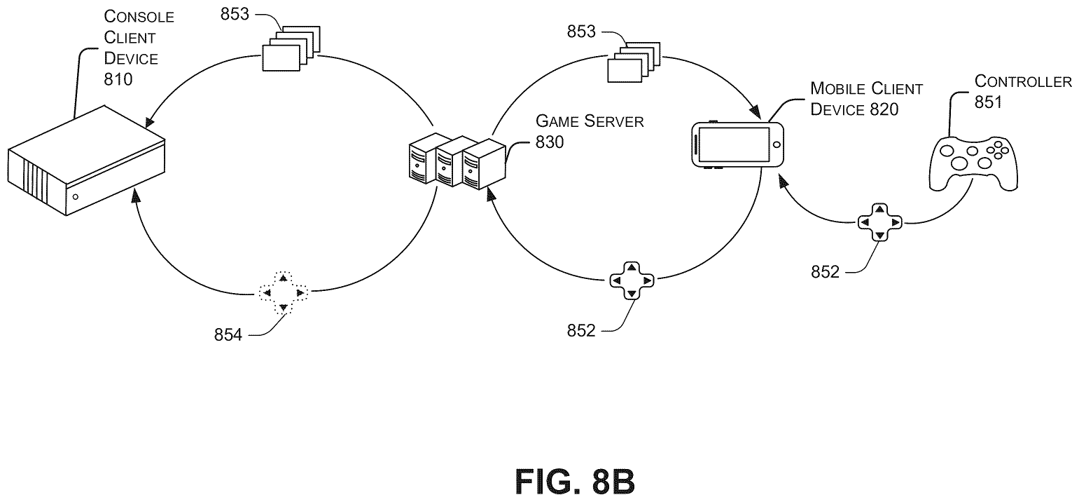

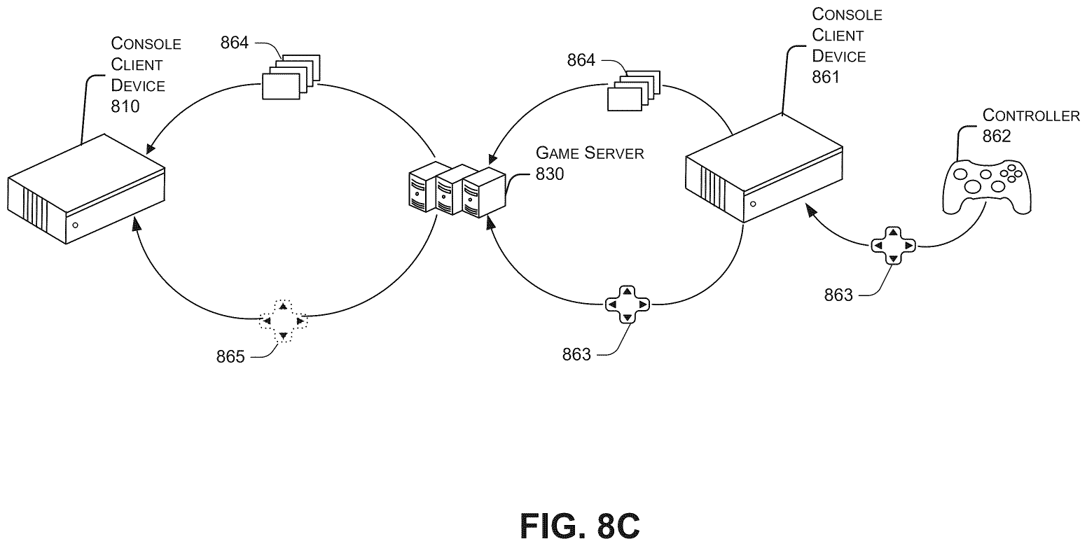

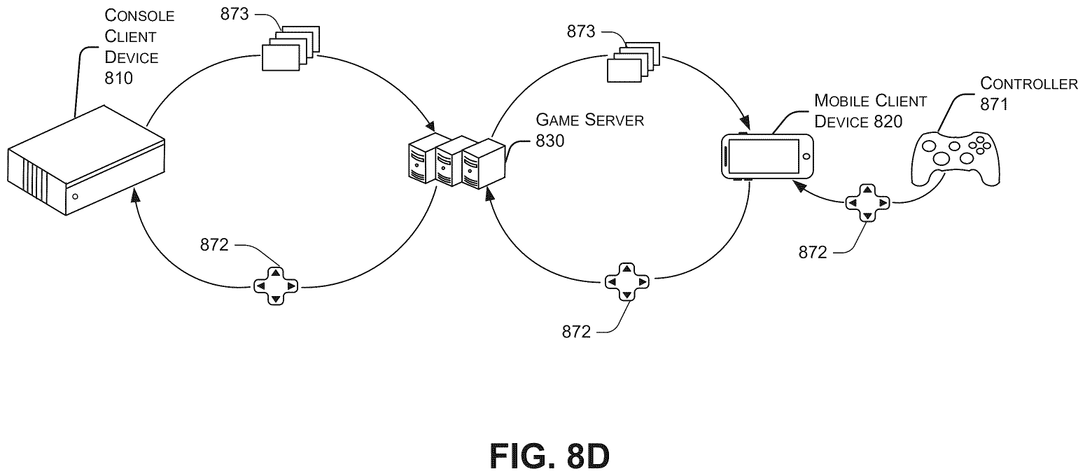

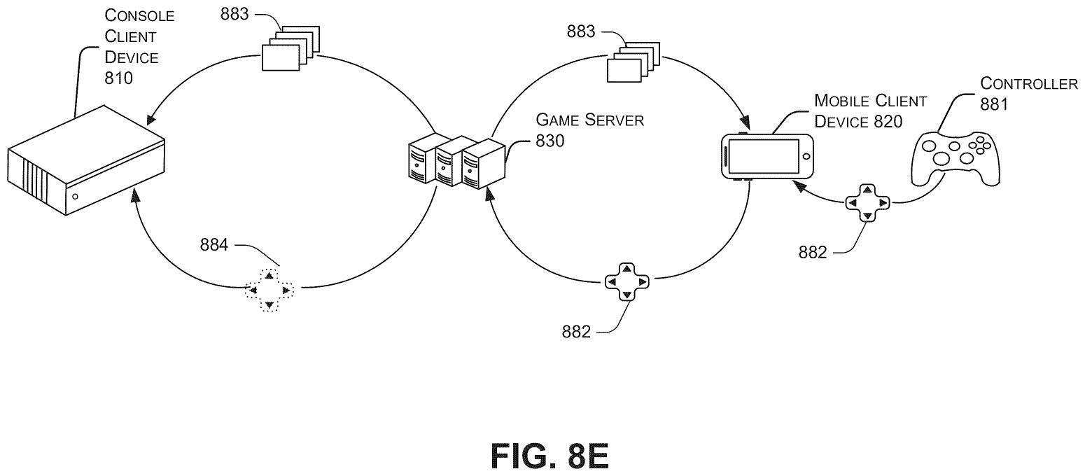

The present concepts can be implemented in various technical environments and on various devices. FIG. 8A shows an example system 800 in which the present concepts can be employed, as discussed more below. As shown in FIG. 8A, system 800 includes a console client device 810, a mobile client device 820, and a game server 830. Console client device 810, mobile client device 820, and server 830 are connected over one or more networks 840.

Console client device 810 can have processing resources 811 and storage resources 812, mobile client device 820 can have processing resources 821 and storage resources 822, and game server 830 can have processing resources 831 and storage resources 832. The devices of system 800 may also have various modules that function using the processing and storage resources to perform the techniques discussed herein, as discussed more below.

Console client device 810 can include a local game application 813 and an operating system 814. The local game application can execute using functionality provided by the operating system. The operating system can obtain control inputs from controller 815, which can include a controller circuit 816 and a communication component 817. The controller circuit can digitize inputs received by various controller mechanisms such as buttons or analog input mechanisms such as joysticks. The communication component can communicate the digitized inputs to the console client device over the local wireless link 818. The control interface module on the console can obtain the digitized inputs and provide them to the local application. The operating system can collect platform data during execution, and the game can collect instrumented game data during execution.

Mobile client device 820 can have a gaming client application 823. The gaming client application can send inputs from a touchscreen on the mobile client device and/or peripheral game controller to the server 830, and can also receive game outputs, such as video, chat, and/or audio streams, from the server(s) and output them via a display, loudspeaker, headset, etc.

Server 830 can include a remote game application 833, which can correspond to a streaming version of a video game. The server 830 can also have a remote gaming service 834, which can execute the remote game application and provide various support services, such as maintaining user accounts, tracking achievements, etc. The remote gaming service can also include a help session module 835 that implements help session workflow 700. For instance, the help session module can evaluate prior gameplay for games offered by the platform and then designate help session triggering/ending conditions as described above.

In some cases, the operating system 814 on console client device 810 can detect the triggering conditions, e.g., by downloading the triggering conditions from remote gaming service 834 and evaluating current session data on the console. In other cases, the console periodically sends current session data to the remote gaming service, and the remote gaming service can determine when to initiate a help session. For games executed on game server 830, the triggering conditions can be detected by the remote gaming service 834 at runtime of individual games.

When a help session is initiated for a game executed on the console client device 810 or the mobile client device 820, the help session can be loaded as a separate process on any of the devices in system 800. For instance, the help session can be cloud-based help session implemented using a streaming instance of the video game, which can be instantiated and executed by the remote gaming service 834. Then, saved game state from that client device and/or stored by the remote gaming service can be used as a help session starting state. For instance, the helper can play a streaming version of the game using console client device 810 and/or mobile client device 820. When completed, the game state of the help session (the “updated help session state”) can be provided to the current video game session on the game server 830 or the client device of the current video game player, and the current user can resume gameplay from that state.

As described more below, other implementations can involve executing a help session on a client device of the video game helper, where streaming output of the video game is provided to a client device of the video game player receiving help. In other cases, the current game session is a streaming cloud session and the help session can be implemented on a local client device of the video game. In other cases, both the current gaming session and the help session are streaming cloud instances of the video game.

### Example Help Session Communications

FIGS. 8B, 8C, 8D, and 8E illustrate examples of communications among the various devices of system 800 for different scenarios. Some additional devices are introduced in the discussion below that are not shown in FIG. 8A due to space constraints.

FIG. 8B shows a scenario where the current video game player plays a local session on console client device 810, and the video game helper uses mobile client device 820 to play a cloud-based help session executed on game server 830. Here, a controller 851 provides video game inputs 852 to the mobile client device 820 (e.g., over a wireless connection), and the mobile client device provides the video game inputs to the game server 830. Game server 830 provides the video game inputs to a cloud-based instance of the video game, and video game outputs 853 are streamed to the mobile client device and the console client device. In addition, the game server streams a video game input representation 854 to the console client device (such as video game controller representation 620), where the video game input representation shows how individual input mechanisms on the controller 851 are activated. The video game input representation can be synchronized with the video game outputs so that the current video game player can see how the helper is using the controller as the video output is displayed. After the help session, the console client device can resume gameplay of the current video game session locally, potentially using updated help session state from the help session.

FIG. 8C shows a scenario where the current video game player plays a local session on console client device 810, and the video game helper plays a local session on executed on console client device 861. Here, a controller 862 provides video game inputs 863 to the console client device 861 (e.g., over a wireless connection), and the console client device 861 executes the help session locally to produce video game outputs 864. The console client device streams the video game inputs and the video game outputs to the game server 830. Game server 830 streams the received video game outputs to the client device 810. In addition, the game server adds a video game input representation 865 (as described above) and streams the video game input representation to the console client device.

FIG. 8D shows a scenario where the current video game player plays a local session on console client device 810, and the video game helper plays a remote session on executed on the console client device 810 of the current video game player. Here, a controller 871 provides video game inputs 872 to the mobile client device 820 (e.g., over a wireless connection), and the mobile client device forwards the inputs to game server 830, which in turn sends the game inputs to the console client device. The console client device 810 directs the inputs to the locally-executed video game, and streams video game outputs 873 to the game server, which in turn streams the video game outputs to the mobile client device. The console client device 810 adds a video game input representation when displaying the video game input to the current video game player.

FIG. 8E shows a scenario where the current video game session and the helper session are both executed on game server 830. Here, a controller 881 provides video game inputs 882 to the mobile client device (e.g., over a wireless connection), and the mobile client device forwards the inputs to game server 830, which in turn provides the game inputs to a cloud instance of the video game executing the help session. The game server sends video game outputs 883 to both the mobile client device and the console client device 810 of the current video game player, and the game server also adds a video game input representation 884 (as described above) that is also sent to the console client device. After the help session, the game server can resume gameplay of the current video game session, potentially using updated help session state from the help session.

### Example Method

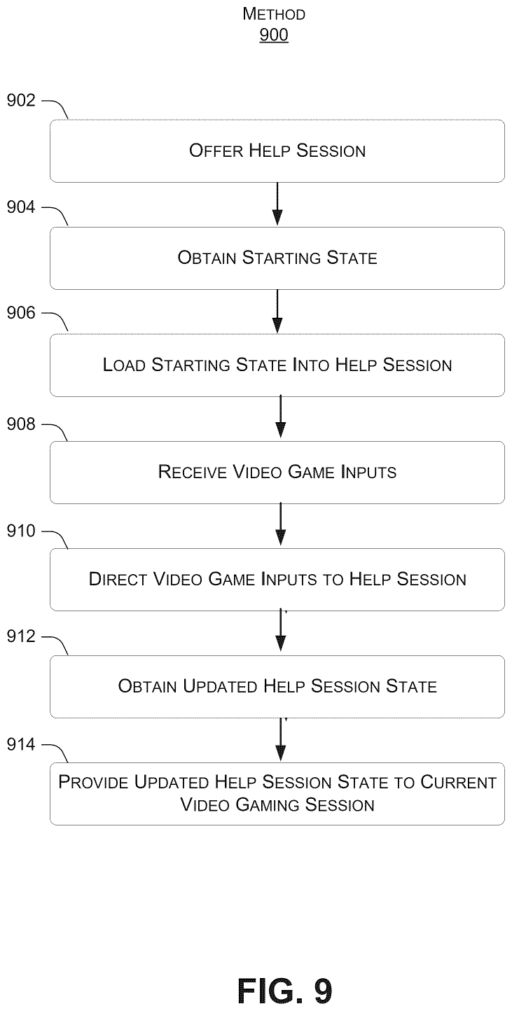

FIG. 9 illustrates an example computer-implemented method 900 that can be used to initiate a help session for a video game for a current video gaming session, consistent with the present concepts. As discussed elsewhere herein, method 900 can be implemented on many different types of devices, e.g., by one or more cloud servers, by a client device such as a laptop, tablet, or smartphone, or by combinations of one or more servers, client devices, etc.

Method 900 begins at block 902, where a help session for a particular video game is offered to a current video game player. For instance, the help session can be a cloud-based help session that executes the video game in the cloud. In other cases, the help session can execute on a client device of the current video game player or a client device of the video game helper.

Method 900 continues at block 904, where a help session starting state is obtained. For instance, in some cases, the help session starting state is obtained by capturing a current state of the video game when the help session is about to start. In other cases, the help session starting state can be obtained by retrieving the help session starting state from one or more cloud saves, from one or more quick resume states stored on a client device, etc.

Method 900 continues at block 906, where the current state is loaded into the help session. For instance, the help session starting state can be loaded into memory on a computing device executing the help session, e.g., a server or a client device. In other cases, the help session starting state is sent over a network to another computing device that will execute the help session.

Method 900 continues at block 908, where video game inputs are received from the helper. For instance, the video game inputs can be received from a wired or wireless video game controller, from a touch screen, from a mouse, a keyboard, a virtual or augmented reality headset, etc. The video game inputs can include analog control values from analog mechanisms, binary control values from buttons, or inputs obtained by processing voice, text, gestures, eye gaze, etc.

Method 900 continues at block 910, where the video game inputs are directed to the help session. For instance, the help session can be implemented in the same process or in a separate process from the process executing the current video game session. When separate processes are employed, the processes can execute on the same computing devices or on different computing devices. The video game inputs can be sent to the device and/or process that executes the help session.

Method 900 continues at block 912, where an updated help session state is obtained. For instance, values in memory at the end of the help session can be stored in persistent storage. In other cases, the updated help session state can correspond to data instrumented to storage by the video game during the help session.

Method 900 continues at block 914, where the updated help session state is provided to the current video game session. For instance, the updated help session state can be provided to the process and/or device that executes the current gaming session. In some cases, the current video game player can accept the updated help session state, the updated help session state is loaded into the current video game session, and the current video game player can continue playing the game from that point onward. In other cases, the updated help session state can be rejected by the current video game player, and the current video game player can revert to previously-saved state and resume playing the game from that earlier state.

### Help Session Triggering and Ending Conditions

The following describes how various approaches can be employed to designate and/or detect help session triggering conditions in video games. Assume prior gameplay data 702 includes many video frames output by the racing game shown above. There may be many crashes at various courses along the track, along with many successful instances of game players successfully navigating the track. The fact that a video game player happens to crash at a given location does not necessarily mean that location would be useful as a triggering condition for help sessions, e.g., if the vast majority of video game players do not crash at that location.

However, assume that there are many instances of video output in prior gameplay data 702 that look very similar to the sequence shown in frame 502, frame 504, frame 506, and frame 508 of FIG. 5A, where the driver crashes into the tree. Further, assume platform data 706 indicates significant disengagement that is temporally correlated with those gameplay sequences. In other words, users are frequently driving the car into the tree shown in frame 508, then performing a restart of the driving game, switching to a different game, or stopping playing video games all together.

Further, assume that there are also a number of sequences of video output in gameplay data 702 that look very similar to frame 512, frame 514, frame 516, and frame 518 of FIG. 5B, where the driver successfully navigates the turn without crashing into the tree. Further, assume the platform data indicates very little disengagement that is temporally correlated with those gameplay sequences. In other words, after driving past the tree as shown in frame 518, video game players are very rarely performing a restart of the driving game, switching to a different game, or stopping playing video games all together.

Using the example above, triggering condition designation processing 704 could designate a help session trigger condition occurring in the video driving game at frame 508. Since this frame shows a game circumstance that is strongly correlated with disengagement, it could be useful to offer help sessions to users when they appear to be struggling at this location on the road course. By looking at current session data 712, such as video output and input during a current gaming session, help session implementation 716 can detect the triggering condition and determine whether to offer the user a help session. For instance, the triggering condition could be detected by comparing one or more embeddings representing a current video frame to one or more embeddings representing frame 502. If the embeddings are sufficiently similar (e.g., within a threshold distance in a vector space) and the user has previously crashed into the tree a threshold number of times (e.g., five), then a help session can be triggered and then subsequently ended after the user successfully navigates past the tree. Note that it can be useful to initiate the help session somewhat before the negative in-game consequence tends to occur so that the helper has time to start playing the game and get acclimated to gameplay.

There are a wide range of techniques that can be employed for designating and detecting help session triggering conditions and help session ending conditions. The following illustrates just a few examples of how to do so.

First, consider a multi-modal generative model that has both computer vision and natural language capabilities. In some cases, numerous examples of video output of a video game could be sufficient for the multi-modal generative to identify that a help session is appropriate. For instance, a multi-modal generative could be trained with example sequences of video output and associated natural language data, such as user comments from a forum or chat log. The multi-modal generative could infer specific in-game conditions that tend to cause user comments to indicate disengagement, e.g., “I'm turning this off and going to bed,” and then the multi-modal generative could correlate those comments with specific video frames. Then, current video frames could be input to the multi-modal generative and the multi-modal model could indicate whether a help session should be triggered based on the current video frames. As but a few examples, a multi-modal generative could learn from training examples that a health bar is low, a user has crashed into a tree or been defeated in a fight, is struggling to find an item or complete a level, etc.

One way to obtain such a model is to start with a pretrained multi-modal generative model and provide training data for multiple games associated with a given genre. Since adventure and fighting games tend to have health bars and battles with enemies, racing games tend to have timers and crashes, etc., it is possible for a multi-modal generative to be tuned to a specific game genre. For instance, a multi-modal generative model could have a transformer architecture that represents images and language tokens in a shared vector space, where images and tokens representing similar concepts are located close together in the vector space and images and tokens representing dissimilar concepts can be located far apart in the vector space. A similar approach can also be implemented by tuning separate computer vision and generative language models using training data for games from a given genre. For instance, a computer vision model could output classifications of objects detected in video frames, and those classifications could be provided to a separate generative language model that has been tuned to detect game difficulty, disengagement, and/or negative in-game consequences based on the classification identified by the computer vision model.

In some cases, a multi-modal generative can be prompted to characterize a given in-game condition. For instance, a multi-modal generative could be prompted with a text description of a game provided by the game developer and one or more video frames, and the text description could allow the multi-modal generative model to more accurately understand what is being shown in video frames from that game. A similar technique could be performed by using a computer vision model to classify objects in a video frame and then input the names of those objects to a generative language model with the text description of the game.

In still further cases, a generative model can be employed to generate a natural language description of an in-game condition. For instance, the natural language could be “the user is approaching a stairway with a wall to their right.” This text description can be correlated to in-game goals such as finding a rare gem, and then a help session triggering condition can be represented using the text description. In some cases, transcripts of video tutorials, forum discussions, and/or in-game chat or voice transcripts can also be input to a generative model to learn which in-game conditions tend to drive disengagement.

Generative models can also determine from prior gameplay data how common certain achievements are, how different audio or controller inputs sequences may correlate to user disengagement, etc. Generative models could also output descriptions of an in-game scenario, e.g., “the user is about to be defeated by a boss on top of a stone bridge” or “the user is having a hard time finding the rare gem on level 7.” These descriptions could be used to trigger help sessions.

In some cases, generative models can also be employed to detect help session ending conditions. For instance, if a given segment of gameplay in prior gameplay data tends to end either with a crash into a tree or successfully navigating a turn, then successful navigation of the turn can be designated as an ending condition for help sessions. Likewise, if a given segment of gameplay tends to end with a user either moving too fast past a turn or slowing down for the turn and finding a rare gem, then finding the rare gem can be designated as an ending condition for help sessions. Models can also be tuned to select help session triggering conditions that occur early enough in gameplay so that the helper has time to react once gameplay begins.

In addition, some implementations can also determine the location of in-game elements such as gems, bosses, or places where frequent crashes occur. For instance, techniques such as photogrammetry or neural radiance fields can be employed to generate three-dimensional construction of a virtual scene provided by a video game. Help sessions can guide users to areas of the virtual scene where they may wish to achieve certain in-game goals.

In further cases, multi-modal generative models, vision models, and/or generative language models can be employed to designate help session triggering conditions and/or ending conditions, but other types of models are employed to detect those conditions during a current gaming session. For instance, a multi-modal generative model could identify a specific video frame as a help session triggering condition and another video frame as a help session ending condition, and embeddings of those video frames could be used to populate a triggering condition database. During gameplay, a smaller vision-only model could run periodically to generate embeddings of current video frames and compare them to the embeddings in the triggering condition database. A similar approach can be employed for audio or haptic output of a video game, and also for controller inputs to the video game. In other words, a help session triggering condition or ending condition could be represented using one or more of video embeddings, audio embeddings, haptic embeddings, and/or controller input sequences.

In further cases, a help session triggering condition can correspond to a video game player explicitly requesting help. For instance, a current video game player might enter text or voice stating, “I need help finding the rare gem near the staircase.” A trained machine learning model could interpret the input to correspond to a specific game segment of the adventure game, and initiate help session for that game segment.

### State Management for Help Sessions

The following describes some approaches that can be employed to manage states during help sessions. Generally speaking, save states for games can be stored on a client device and/or in the cloud, e.g., on game server 830. Save states can be used as help session starting states under certain circumstances. Once the help session completes, the updated help session state can be provided to the current video game session for the current video game player to accept or reject, as discussed elsewhere herein.

In some implementations, video game save states are maintained by remote gaming service 834 and stored on game server 830. For instance, the remote gaming service can periodically snapshot game state for games executed on the game server itself, save the game state each time a user ends a gaming session, etc. For games executed locally on console client device 810 (or another type of client device), the operating system can periodically snapshot the game state or save the game state each time a user ends a gaming session, and then communicate that saved game state to the game server 830. In some cases, individual games manage their own save states, and may provide an application programming interface that can be called by the operating system or remote game service to cause the game to save its current state. Cloud saves can be employed as help session starting states for both cloud help session and client-executed help sessions, e.g., by sending a cloud save state to a client device that executes a given help session.

In other cases, “quick resume” saves are employed. For instance console client device 810 may have functionality that caches data stored in random-access memory on a solid-state drive whenever a user turns off the console or switches games. Quick resume saves can be employed as help session starting states for client-executed help sessions by loading them into memory of a console from storage. Quick resume saves can also be employed as help session starting states for cloud sessions, e.g., by sending a quick resume save state to the game server 830 for execution of a streaming help session or for the game server to send to another client device of the video game helper to load into a help session on that client device.

In some cases, help session save states are loaded into memory by the operating system and/or remote gaming service, and the game executable can be initiated with that state loaded into memory In other implementations, a deep link to game state can be provided to a running instance of a game, which can load the game state into its own memory upon receiving the deep link. Updated help session states can also be provided to instances of a video game using deep links in a similar manner.

In other implementations, help sessions can be prevented under certain circumstances. For instance, if a current save state is not available for a particular video game player, that player may be prevented from loading a help session until a more recent save state is created. For instance, the save state may need to have been saved within a time threshold, e.g., within the last 24 hours. In still further implementations, an application programming interface call can be made to a video game to cause that video game to save the current state, e.g., for use as a help session starting state.

In some cases, current game state may be saved automatically in response to detecting a help session triggering condition during a current gaming session. For instance, an operating system or remote gaming service can monitor or periodically snapshot game output. The game output can be analyzed to detect a help session triggering condition. If the operating system or remote gaming service detects a help session triggering condition, the operating system or remote gaming service can cause the current game state to be saved in the cloud or on a client computing device for subsequent use as a help session starting state. In other implementations, individual games can perform similar techniques by auto-saving game state for help sessions when triggering conditions are detected.

In addition, video game players can have the option of accepting or rejecting updated help session states. Referring back to FIG. 8A, assume that NewGuy42 is playing the adventure game on console client device 810. Referring back to FIG. 6B, assume that NewGuy42 elects to save game state and accept the help session. At this time, the console computing device 810 can save the game state locally, and send the game state to the game server 830. The game server can load the game state into a new help session and execute a streaming version of the game. LuckySeven can use mobile client device 820 (e.g., with a wireless video game controller) to play the streaming version of the game. When the help session ends, NewGuy42 can choose to accept the updated help state. If so, the updated help state is transmitted from the game server to the console. Otherwise, the help state is discarded. At any time, NewGuy42 can end the streaming session by entering a designated control sequence, at which point NewGuy42 can elect to take over from that point or revert to the saved state prior to the help session.

In still further implementations, a demonstration mode is offered where a helper can conduct a help session, but the results of that help session do not persist. In other words, after the help session, the console computing device 810 can revert to the prior game state and the current video game player can attempt to complete an in-game goal on their own after viewing the demonstration. As noted, some implementations may offer the current video game player the option of accepting the resulting video game state after a help session and loading that state into their current video game session, or alternatively rejecting that state and resuming the current video game session from the state saved prior to initiating the help session.

Furthermore, note that some implementations can utilize the techniques described above for detecting help session triggering conditions for other purposes. For instance, consider a video game where a specific point in the game tends to be strongly correlated with disengagement. As described above, help sessions can be offered to video game players at that point in the video game. In addition, some implementations can take further actions to mitigate disengagement relating to that point in the game. For instance, the operating system and/or remote gaming service can call an application programming interface that prompts the video game to save debug data when that point is reached in the game by any video game player, irrespective of whether a help session is also offered. This can enable the game developer to decide what information they would like to collect to remedy disengagement rates. For instance, the video game developer might decide to instrument player location, health, inventory status, or other information whenever the game reaches a point where disengagement tends to occur. This additional information could help the game developer update the game to mitigate disengagement at that point in the game.

In other implementations, the operating system or remote gaming platform can automatically save game state whenever a point is reached in a game where disengagement tends to occur. For instance, as noted above, various techniques can be employed to evaluate game state to determine when a help session triggering condition is identified. In some cases, a help session is not necessarily triggered, but the operating system or remote gaming service can automatically save game state when such a triggering condition is detected in the output of the video game. This information can be provided to game developers so that they can take actions, such as modifying game code, to mitigate disengagement relating to that point in the game.

In some cases, the operating system or remote gaming service can also determine that a remedy is available for a specific point in a game where disengagement has been extensive and offer that remedy to video game players who previously disengaged from the video game. For instance, assume an update to a video game is released and, after a period of time, the operating system or remote gaming service detects that disengagement relating to the same point in the game have decreased as a result of the update. The operating system and/or remote gaming service can output a communication to video game players who previously disengaged at that point to let them know that the issue has been resolved and that they may wish to try playing the game again. As an alternative, the operating system and/or remote gaming service can output a communication to inform video game players that human and/or automated helpers are available to conduct help sessions relating to that point in the game.

### Helper Selection

The following generally describes how helpers can be selected for a given help session when performing help session workflow 700. In some implementations, helper database 710 can be populated with general information relating to a given helper. For instance, an overall average rating (e.g., number of stars) for each helper can be stored in the helper database. Then, this information can be employed to select a helper for a current session, e.g., by selecting a highly-rated helper at a time when a current video game session results in a help session triggering condition.

In other implementations, helper database 710 can be populated using more game-specific information. For instance, each video game can have a separate rating for different games. Thus, referring back to FIG. 6C, LuckySeven might be highly-rated for the adventure game, but have a lower rating for other games such as the driving game. In this case, helpers can be selected on a game-specific basis, e.g., by selecting a highly-rated helper for a particular video game at a time when a current video game session involving that game results in a help session triggering condition.

In still further implementations, each help session triggering condition and/or help session ending condition can be associated with a specific help segment. Individual helpers can be evaluated based on their ratings for specific help segments. Thus, for instance, if LuckySeven has been relatively successful at helping adventure game players find the rare gem but has had more difficulty helping with other game segments (e.g., finding a sword later in the game), then LuckySeven may have a lower rating for those segments than for the segment that involves finding the rare gem. In this case, helpers can be selected on a segment-specific basis, e.g., by selecting a highly-rated helper for a particular video game segment at a time when a current video game session involving that game segment results in a help session triggering condition.

Helpers can also be selected based on other criteria, such as a percentage of other players that have accepted updated help session state for a given helper, or sentiment analysis of text or voice communication between helpers and video game players during or after help sessions. These criteria can be tracked over multiple video games, on a video game-specific basis, and/or on a segment-specific basis.

In further implementations, machine learning can be applied to video output associated with save states and/or to other save state data to choose a helper. For instance, a generative multi-modal model could process video output associated with a save state and output a message such as “This user needs help finding the rare gem near the staircase.” In other cases, the current video game player themselves could provide similar input, e.g., “I need help finding the rare gem near the staircase.” In either case, the natural language description could be used to select a helper that is highly rated for that segment. In other cases, the save state itself can be in a binary or computer language format (e.g., JavaScript Object Notation or JSON) and a machine learning model can be trained to extract help segment information directly from the save state to select a helper.

### Technical Effect

As noted above, the disclosed implementations can be employed to automatically designate and detect help session triggering conditions. As a result, human-computer interaction can be improved by having a computer initiate a help session for a user. For instance, users may not be able to accurately determine when a help session is appropriate to initiate or to terminate. Using the disclosed techniques, specific in-game circumstances can be accurately detected and help sessions can be offered in a manner that encompasses scenarios where help is appropriate, based on prior interactions by other users with a given video game.

In further implementations, specific techniques can be employed to preserve processing, memory, and/or network bandwidth. For instance, some implementations can snapshot video output of a given game at a specified interval, e.g., every 30 seconds. Thus, instead of analyzing every video frame, far fewer frames are analyzed, and computing resources can be conserved. As another example of computing resource preservation, a large server-based generative model can be employed to evaluate massive amounts of prior gameplay data and designate help session triggering or ending conditions. Then, those conditions can be distributed to client devices where smaller (e.g., vision-only) models can detect the conditions in video game output and trigger help sessions.

In addition, the disclosed techniques also provide for automated save management techniques that further improve human-computer interaction. Consider an alternative where video game players manually save their state prior to a help session. Many video game players might forget to do so. By automating the selection of save states to use as help session starting states, prompting users to save their current state prior to starting a help session, and giving users the option to accept or reject updated help session states after a help session, the disclosed techniques can alleviate a great deal of user input that would otherwise be involved in having users manage their own save states.

### Device Implementations

As noted above with respect to FIG. 8A, system 800 includes several devices, including a console client device 810, a mobile client device 820, and a game server 830. As also noted, not all device implementations can be illustrated, and other device implementations should be apparent to the skilled artisan from the description above and below.

The term “device,” “computer,” “computing device,” “client device,” and or “server device” as used herein can mean any type of device that has some amount of hardware processing capability and/or hardware storage/memory capability. Processing capability can be provided by one or more hardware processors (e.g., hardware processing units/cores) that can execute data in the form of computer-readable instructions to provide functionality. Computer-readable instructions and/or data can be stored on storage, such as storage/memory and or the datastore. The term “system” as used herein can refer to a single device, multiple devices, etc.

Storage resources can be internal or external to the respective devices with which they are associated. The storage resources can include any one or more of volatile or non-volatile memory, hard drives, flash storage devices, and/or optical storage devices (e.g., CDs, DVDs, etc.), among others. As used herein, the term “computer-readable medium” can include signals. In contrast, the term “computer-readable storage medium” excludes signals. Computer-readable storage media includes “computer-readable storage devices.” Examples of computer-readable storage devices include volatile storage media, such as RAM, and non-volatile storage media, such as hard drives, optical discs, and flash memory, among others.

In some cases, the devices are configured with a general purpose hardware processor and storage resources. In other cases, a device can include a system on a chip (SOC) type design. In SOC design implementations, functionality provided by the device can be integrated on a single SOC or multiple coupled SOCs. One or more associated processors can be configured to coordinate with shared resources, such as memory, storage, etc., and/or one or more dedicated resources, such as hardware blocks configured to perform certain specific functionality. Thus, the term “processor,” “hardware processor” or “hardware processing unit” as used herein can also refer to central processing units (CPUs), graphical processing units (GPUs), controllers, microcontrollers, processor cores, or other types of processing devices suitable for implementation both in conventional computing architectures as well as SOC designs.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

In some configurations, any of the modules/code discussed herein can be implemented in software, hardware, and/or firmware. In any case, the modules/code can be provided during manufacture of the device or by an intermediary that prepares the device for sale to the end user. In other instances, the end user may install these modules/code later, such as by downloading executable code and installing the executable code on the corresponding device.

Also note that devices generally can have input and/or output functionality. For example, computing devices can have various input mechanisms such as keyboards, mice, touchpads, voice recognition, gesture recognition (e.g., using depth cameras such as stereoscopic or time-of-flight camera systems, infrared camera systems, RGB camera systems or using accelerometers/gyroscopes, facial recognition, etc.). Devices can also have various output mechanisms such as printers, monitors, etc.

Also note that the devices described herein can function in a stand-alone or cooperative manner to implement the described techniques. For example, the methods and functionality described herein can be performed on a single computing device and/or distributed across multiple computing devices that communicate over network(s) 840. Without limitation, network(s) 840 can include one or more local area networks (LANs), wide area networks (WANs), the Internet, and the like.

Various examples are described above. Additional examples are described below. One example includes a computer-implemented method comprising during a current gaming session, offering a current video game player a cloud-based help session relating to a particular video game, obtaining a help session starting state from a saved state of game play by the current video game player, loading the help session starting state into a cloud-based help session of the particular video game, receiving video game inputs from a client device of a video game helper during the cloud-based help session, directing the video game inputs to the cloud-based help session while sending streaming output of the particular video game to the client device of the video game helper, obtaining an updated help session state of the particular video game after the cloud-based help session, and in at least one instance, providing the updated help session state to the current gaming session.

Another example can include any of the above and/or below examples where the method further comprises during the cloud-based help session, sending the streaming video output of the particular video game to another client device of the current video game player.

Another example can include any of the above and/or below examples where the method further comprises sending an indication of the video game inputs received from the video game helper to the another client device with the streaming output of the particular video game.

Another example can include any of the above and/or below examples where the indication comprising a graphical representation of a video game controller with controller inputs synchronized to the streaming video output.

Another example can include any of the above and/or below examples where the current gaming session being a locally-executed session on another client device of the current video game player.

Another example can include any of the above and/or below examples where the current gaming session being another cloud-based session.

Another example can include any of the above and/or below examples where the method further comprises prompting the current video game player to save a current state of the particular video game responsive to acceptance of the cloud-based help session, and using the current state as the help session starting state.

Another example can include any of the above and/or below examples where the method further comprises prompting the current video game player to accept or reject the updated help session state, and in an instance when the current video game player accepts the updated help session state, loading the updated help session state into the current gaming session.

Another example can include any of the above and/or below examples where the method further comprises calling an application programming interface that instructs the particular video game to save a current game state, and using the current game state as the help session starting state.

Another example can include any of the above and/or below examples where providing the updated help session state to the current video game session comprises generating a link to the updated help session state and sending the link to the particular video game, wherein the particular video game is configured to retrieve the updated help session state via the link and resume execution from the updated help session state.

Another example can include any of the above and/or below examples where the method further comprises retrieving the help session starting state from one or more quick resume saves on a console client device of the current video game player, or retrieving the help session starting state from one or more cloud saves stored for the current video game player.

Another example can include any of the above and/or below examples where the method further comprises detecting a help session triggering condition during the current gaming session, and automatically saving the help session starting state responsive to detecting the help session triggering condition.

Another example can include a system comprising processing resources, and storage resources storing computer-readable instructions which, when executed by the processing resources, cause the processing resources to during a current gaming session, offer a current video game player a cloud-based help session relating to a particular video game, obtain a help session starting state from a saved state of game play by the current video game player, load the help session starting state into a cloud-based help session of the particular video game, receive video game inputs from a client device of a video game helper during the cloud-based help session, direct the inputs to the cloud-based help session while sending streaming output of the particular video game to the client device of the video game helper, obtain an updated help session state of the particular video game after the cloud-based help session, and in at least one instance, provide the updated help session state to the current gaming session.

Another example can include any of the above and/or below examples where the computer-readable instructions, when executed by the processing resources, cause the processing resources to analyze the help session starting state to select the video game helper.

Another example can include any of the above and/or below examples where the computer-readable instructions, when executed by the processing resources, cause the processing resources to analyze the help session starting state by inputting the help session starting state to a trained machine learning model and select the video game helper based on output of the machine learning model.

Another example can include any of the above and/or below examples where the help session starting state comprising a binary format or a computer language format.

Another example can include any of the above and/or below examples where the help session starting state comprising video output of the particular video game.

Another example can include any of the above and/or below examples where the computer-readable instructions, when executed by the processing resources, cause the processing resources to receive natural language input from the current video game player requesting help and select the video game helper based on the natural language input.

Another example can include any of the above and/or below examples where the computer-readable instructions, when executed by the processing resources, cause the processing resources to access help session data for help sessions by a plurality of helpers, and select the helper based on the help session data.

Another example can include a computer-readable storage medium storing computer-readable instructions which, when executed by a hardware processing unit, cause the hardware processing unit to perform acts comprising during a current gaming session, offering a current video game player a cloud-based help session relating to a particular video game, obtaining a help session starting state from a saved state of game play by the current video game player, loading the help session starting state into a cloud-based help session of the particular video game, receiving video game inputs from a client device of a video game helper during the cloud-based help session, directing the inputs to the cloud-based help session while sending streaming output of the particular video game to the client device of the video game helper, obtaining an updated help session state of the particular video game after the cloud-based help session, and in at least one instance, providing the updated help session state to the current gaming session.

### CONCLUSION

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and other features and acts that would be recognized by one skilled in the art are intended to be within the scope of the claims.

1. A computer-implemented method comprising:
during a current gaming session, offering a current video game player a cloud-based help session relating to a particular video game;
obtaining a help session starting state from a saved state of game play by the current video game player;
loading the help session starting state into a cloud-based help session of the particular video game;
receiving video game inputs from a client device of a video game helper during the cloud-based help session;
directing the video game inputs to the cloud-based help session while sending streaming output of the particular video game to the client device of the video game helper;
obtaining an updated help session state of the particular video game after the cloud-based help session; and
in at least one instance, providing the updated help session state to the current gaming session.

2. The computer-implemented method of claim 1, further comprising:
during the cloud-based help session, sending the streaming video output of the particular video game to another client device of the current video game player.

3. The computer-implemented method of claim 2, further comprising:
sending an indication of the video game inputs received from the video game helper to the another client device with the streaming output of the particular video game.

4. The computer-implemented method of claim 3, the indication comprising a graphical representation of a video game controller with controller inputs synchronized to the streaming video output.

5. The computer-implemented method of claim 1, the current gaming session being a locally-executed session on another client device of the current video game player.

6. The computer-implemented method of claim 1, the current gaming session being another cloud-based session.

7. The computer-implemented method of claim 1, further comprising:
prompting the current video game player to save a current state of the particular video game responsive to acceptance of the cloud-based help session; and
using the current state as the help session starting state.

8. The computer-implemented method of claim 1, further comprising:
prompting the current video game player to accept or reject the updated help session state; and
in an instance when the current video game player accepts the updated help session state, loading the updated help session state into the current gaming session.

9. The computer-implemented method of claim 1, further comprising:
calling an application programming interface that instructs the particular video game to save a current game state; and
using the current game state as the help session starting state.

10. The computer-implemented method of claim 1, wherein providing the updated help session state to the current video game session comprises:
generating a link to the updated help session state; and
sending the link to the particular video game,
wherein the particular video game is configured to retrieve the updated help session state via the link and resume execution from the updated help session state.

11. The computer-implemented method of claim 1, further comprising:
retrieving the help session starting state from one or more quick resume saves on a console client device of the current video game player; or
retrieving the help session starting state from one or more cloud saves stored for the current video game player.

12. The computer-implemented method of claim 1, further comprising:
detecting a help session triggering condition during the current gaming session; and
automatically saving the help session starting state responsive to detecting the help session triggering condition.

13. A system comprising:
processing resources; and
storage resources storing computer-readable instructions which, when executed by the processing resources, cause the processing resources to:
during a current gaming session, offer a current video game player a cloud-based help session relating to a particular video game;
obtain a help session starting state from a saved state of game play by the current video game player;
load the help session starting state into a cloud-based help session of the particular video game;
receive video game inputs from a client device of a video game helper during the cloud-based help session;
direct the inputs to the cloud-based help session while sending streaming output of the particular video game to the client device of the video game helper;
obtain an updated help session state of the particular video game after the cloud-based help session; and
in at least one instance, provide the updated help session state to the current gaming session.

14. The system of claim 13, wherein the computer-readable instructions, when executed by the processing resources, cause the processing resources to:
analyze the help session starting state to select the video game helper.

15. The system of claim 14, wherein the computer-readable instructions, when executed by the processing resources, cause the processing resources to:
analyze the help session starting state by inputting the help session starting state to a trained machine learning model; and
select the video game helper based on output of the machine learning model.

16. The system of claim 15, the help session starting state comprising a binary format or a computer language format.

17. The system of claim 15, the help session starting state comprising video output of the particular video game.

18. The system of claim 13, wherein the computer-readable instructions, when executed by the processing resources, cause the processing resources to:
receive natural language input from the current video game player requesting help; and
select the video game helper based on the natural language input.

19. The system of claim 13, wherein the computer-readable instructions, when executed by the processing resources, cause the processing resources to:
access help session data for help sessions by a plurality of helpers; and
select the helper based on the help session data.

20. A computer-readable storage medium storing computer-readable instructions which, when executed by a hardware processing unit, cause the hardware processing unit to perform acts comprising:
during a current gaming session, offering a current video game player a cloud-based help session relating to a particular video game;
obtaining a help session starting state from a saved state of game play by the current video game player;
loading the help session starting state into a cloud-based help session of the particular video game;
receiving video game inputs from a client device of a video game helper during the cloud-based help session;
directing the inputs to the cloud-based help session while sending streaming output of the particular video game to the client device of the video game helper;
obtaining an updated help session state of the particular video game after the cloud-based help session; and
in at least one instance, providing the updated help session state to the current gaming session.
